(19) United States
(12) Patent Application Publication
(10) Pub. No.: US 2013/0279395 A1
(43) Pub. Date: Oct. 24, 2013

(54) MOBILE COMMUNICATION SYSTEM, MOBILE STATION DEVICE, BASE STATION DEVICE, SGSN, GGSN, MME, MBMS GW AND MOBILE COMMUNICATION METHOD

(71) Applicants: Masafumi Aramoto, Osaka-shi (JP); Katsuyuki Machino, Osaka-shi (JP); Junji Hiraide, Osaka-shi (JP); Masayuki Enomoto, Osaka-shi (JP)

(72) Inventors: Masafumi Aramoto, Osaka-shi (JP); Katsuyuki Machino, Osaka-shi (JP); Junji Hiraide, Osaka-shi (JP); Masayuki Enomoto, Osaka-shi (JP)

(73) Assignee: SHARP KABUSHIKI KAISHA, Osaka-shi, Osaka (JP)

(21) Appl. No.: 13/883,829

(22) PCT Filed: Nov. 8, 2011
(86) PCT No.: PCT/JP2011/075706

§ 371 Date: Jul. 11, 2013

(30) Foreign Application Priority Data
Nov. 8, 2010 (JP) 2010-250285
Nov. 8, 2010 (JP) 2010-250286

(51) Int. Cl. H04W 72/00

(52) U.S. Cl. CPC H04W 72/005
USPC 370/312

(57) ABSTRACT

To provide a mobile communication system and the like that can efficiently use network resources, by defining a control method of releasing network resources by a counting function of a base station device. In a mobile communication system that performs distribution of broadcast data by an MBMS bearer service, from a BM-SC to a mobile station device that is connected to a base station device, via a GGSN and an SGSN for which an MBMS bearer has been established, the base station device transmits a session stop request associated with the MBMS bearer context to the SGSN when stopping the distribution of broadcast data associated with the MBMS bearer context, and stops distribution of broadcast data to thereby release the MBMS bearer resources between the base station device and the SGSN.

### TECHNICAL FIELD

The present invention relates to a mobile communication system and the like for distributing broadcast data by an MBMS bearer service, from a BM-SC to a mobile station device which is connected to abase station device, via a GGSN and an SGSN or via an MBMS GW and an MME, for which an MBMS bearer has been established.

### BACKGROUND ART

In 3GPP, as a method of providing MBMS bearer services for performing multicast data distribution and broadcast data distribution by GPRS (General Packet Radio Service), MBMS (Multimedia Broadcast/Multicast Service) has been standardized.

Also, in 3GPP, as a method of providing MBMS bearer services for performing multicast data distribution and broadcast data distribution by EPS (Evolved Packet System), MBMS (Multimedia Broadcast/Multicast Service) has been standardized.

For example, according to Non-patented Document 1, an MBMS service area is defined as a range within which a certain MBMS session is implemented. For example, a service area may be set up in a regional unit such as the whole of Japan, the Kanto region or the like and constructed by cells of multiple base station devices in the service area. Broadcast distribution paths are set up on radio access networks such as UTRAN and the like that are connected to the core network while the base station devices (Node B) of individual cells in the service area and radio network controllers (RNC) set up MBMS bearers for terminals (UE) and deliver the data.

Further, according to Non-patent Document 1, an MBMS service area is defined as a range within which a certain MBMS session is implemented. For example, a service area may be set up in a regional unit such as the whole of Japan, the Kanto region or the like and constructed by cells of multiple base station devices in the service area. Broadcast distribution paths are set up on radio access networks such as E-UTRAN and the like that are connected to the core network while the base station devices (eNode B)) of individual cells in the service area set up MBMS bearers for terminals (UE) and deliver the data.

In the thus practiced conventional broadcast data distribution, data is distributed in MBMS service area units, instead of cellular or base station units. Therefore, even when there is a cell in which no terminal to be distributed exists in the MBMS service area, the broadcast data is delivered to the base station device of the cell.

It is expected in the future that broadcast data distribution services of this kind will diversify such as, for example use of broadcast services targeting at limited narrow areas will increase in addition to the conventional broadcast services targeting at relatively large service areas.

Furthermore, it is expected that such diversification of service styles will further diversify the broadcast data to be distributed, ranging from those publicly used and widely distributed to those oriented to personal communities and others and that categories of data will markedly increase.

For example, a use case of a guide tour for travels and the like as described in Non-patent document 2 can be considered. Also considered are broadcast services that are targeted at the visitors of customer-attracting facilities such as sport events, concert venues, shopping centers and the like. Moreover, it is possible to apply the service to a case for distributing information only to sufferers in a disaster-stricken area.

In the conventional art, without performing any optimization for the trend of the service styles and kinds of distributed data being diversified, communication channels such MBMS bearers and the like is established in an identical manner for all kinds of broadcast distribution data so that the data is transmitted without regard to whether receiver terminals exist or not.

Recently, study on the counting function of letting the base station device count the number of terminals that are receiving broadcast data has been started. When detecting that no receiver terminal exists, the base station device releases the radio-link communication band assigned for delivery of broadcast data between the base station device and terminals or performs optimization by mode change or the like so as to efficiently use the resources of the radio section. Further, when a terminal appears once again, radio resources are re-assigned. In this way, study on efficient usage of radio resources based on the counting function is in progress.

### PRIOR ART DOCUMENTS

### Non-Patent Documents

Non-patent Document 1:
TS 23.246, Technical Specification Group Services and Architecture; Multimedia Broadcast/Multicast Service (MBMS); Architecture and functional description
Non-patent Document 2:
3GPP TR 22.947, Technical Specification Group Services and System Aspects; Study on Personal Broadcast Service

### DISCLOSURE OF THE INVENTION

### Problems to be Solved by the Invention

The efficient improvement technique based on the result of counting in the conventional base station device is only aimed at efficient use of the resources in the radio communication section between a base station device and terminals, and there has been no method of efficiently using the resources in the communication section inside the network from the sender device of broadcast data to the base station device.

That is, even if the base station device, based on the counting function, has detected that no terminal receiving broadcast data exists, the broadcast data ends up being delivered from the broadcast sender device installed inside the network to the base station device. Up to now, there has been no solving method of efficiently using network resources by cutting down the unnecessary traffic of this kind.

Thus, the efficient usage of the radio resources between the base station device and terminals has been considered up to now by use of the counting function, but the network resources within the network cannot be efficiently used.

The above-mentioned non-patent document 1 shows a procedure of releasing network resources of terminals, but the method only teaches the procedure of releasing network resources when the broadcast data sender device installed inside the network detects that there will be no more data to send.

In other words, there has been a method whereby the broadcast data sender device initiatively releases and re-assign network resources, but the base station device could not do these tasks initiatively.

As a result, when the base station device, based on the counting result, detects that no data receiving terminal exists, that a terminal has moved off to another base station device without making a resource release request, that a terminal has been turned off, and other cases, it has been impossible to improve efficiency despite the fact that no network resource is actually used.

In order to solve the above problems, it is therefore an object of the present invention to provide a mobile communication system and the like that can achieve efficient usage of network resources by determining a control method of releasing network resources based on the counting function of a base station device.

### Means for Solving the Problems

In order to solve the above problems, a mobile communication system of the present invention is, in a mobile communication system that performs distribution of broadcast data by an MBMS bearer service, from a BM-SC (Broadcast Multicast Service Center) to a mobile station device that is connected to a base station device, via a GGSN (Gateway GPRS Support Node) and an SGSN (Service GPRS Support Node) for which an MBMS (Multimedia Broadcast/Multicast Service) bearer has been established, characterized in that,

in the MBMS bearer service, information on the MBMS bearer established by assigning MBMS bearer resources is included in an MBMS bearer context, and

the base station device transmits a session stop request associated with the MBMS bearer context to the SGSN when stopping the distribution of broadcast data associated with the MBMS bearer context, and stops distribution of broadcast data to thereby release the MBMS bearer resources between the base station device and the SGSN.

A mobile communication system of the present invention is, in a mobile communication system that performs distribution of broadcast data by an MBMS bearer service, from a BM-SC (Broadcast Multicast Service Center) to a mobile station device that is connected to a base station device, via an MBMS GW (MBMS Gateway) and an MME (Mobility Management Entity) for which an MBMS (Multimedia Broadcast/Multicast Service) bearer has been established, characterized in that,

in the MBMS bearer service, information on the MBMS bearer established by assigning MBMS bearer resources is included in an MBMS bearer context, and

the base station device transmits a session stop request associated with the MBMS bearer context to the MME and requests the MBMS GW to stop the session when stopping the distribution of broadcast data associated with the MBMS bearer context, and stops distribution of broadcast data to thereby release the MBMS bearer resources between the base station device and the MBMS GW.

The mobile communication system of the present invention is characterized in that the MBMS bearer context further includes a service identifier for identifying an MBMS bearer service, and

the base station device transmits a confirmation message including a service identifier to the mobile station devices and counts the number of mobile station devices joining the distribution of broadcast data, based on the replay from the mobile station devices, and determines suspension of the distribution of broadcast data when the counted number is zero.

The mobile communication system of the present invention is characterized in that the service identifier includes a TMGI (Temporary Mobile Group Identify).

The mobile communication system of the present invention is characterized in that the base station device transmits a session stop request to the SGSN and stops transmission and reception of IP multicast packets at the same time.

The mobile communication system is characterized in that the base station device transmits a session stop request to the MME and stops transmission and reception of IP multicast packets at the same time.

The mobile communication system is characterized in that the SGSN transmits a session stop request associated with the MBMS bearer context to the GGSN when there is no mobile station device that is being connected via the SGSN and receiving distribution of broadcast data, and stops distribution of broadcast data to thereby release the MBMS bearer resources between the SGSN and the GGSN.

The mobile communication system is characterized in that the MME transmits a session stop request associated with the MBMS bearer context to the MBMS GW when there is no mobile station device that is being connected to the base station which transmits the session stop request and receiving distribution of broadcast data, and stops distribution of broadcast data to thereby release the MBMS bearer resources between the MBMS GW and the base station device.

The mobile communication system is characterized in that the GGSN transmits a session stop request associated with the MBMS bearer context to the BM-SC when there is no mobile station device that is being connected via the GGSN and receiving distribution of broadcast data, and stops distribution of broadcast data to thereby release the MBMS bearer resources between the GGSN and the BM-SC.

The mobile communication system is characterized in that the MBMS GW transmits a session stop request associated with the MBMS bearer context to the BM-SC when there is no mobile station device that is being connected via the MBMS GW and receiving distribution of broadcast data, and stops distribution of broadcast data to thereby release the MBMS bearer resources between the MBMS GW and the BM-SC.

A mobile station device of the present invention is characterized by being connected to the mobile communication system described above.

A base station device of the present invention is, in a base station device connected to a mobile communication system that performs distribution of broadcast data by an MBMS bearer service, from a BM-SC to a mobile station device that is connected to a base station device, via a GGSN and an SGSN for which an MBMS bearer has been established, characterized in that,

in the MBMS bearer service, information on the MBMS bearer established by assigning MBMS bearer resources is included in an MBMS bearer context, and

the base station device transmits a session stop request associated with the MBMS bearer context to the SGSN when stopping the distribution of broadcast data associated with the MBMS bearer context, and stops distribution of broadcast data to thereby release the MBMS bearer resources between the base station device and the SGSN.

A base station device of the present invention is, in a base station device connected to a mobile communication system that performs distribution of broadcast data by an MBMS bearer service, from a BM-SC to a mobile station device that is connected to a base station device, via an MBMS GW and an MME for which an MBMS bearer has been established, characterized in that,

the MBMS bearer context further includes a service identifier for identifying an MBMS bearer service, and

the base station device transmits a session stop request associated with the MBMS bearer context to the MME when stopping the distribution of broadcast data associated with the MBMS bearer context, and stops distribution of broadcast data to thereby release the MBMS bearer resources between the base station device and the MME.

An SGSN of the present invention is, in an SGSN connected to a mobile communication system that performs distribution of broadcast data by an MBMS bearer service, from a BM-SC to a mobile station device that is connected to a base station device, via a GGSN and an SGSN for which an MBMS bearer has been established, characterized in that,

in the MBMS bearer service, information on the MBMS bearer established by assigning MBMS bearer resources is included in an MBMS bearer context,

the base station device transmits a session stop request associated with the MBMS bearer context to the SGSN when stopping the distribution of broadcast data associated with the MBMS bearer context, and

the SGSN transmits a session stop request associated with the MBMS bearer context to the GGSN when there is no mobile station device that is being connected via the SGSN and receiving distribution of broadcast data, in accordance with the session stop request transmitted from the base station device, and stops distribution of broadcast data to thereby release the MBMS bearer resources between the SGSN and the GGSN.

An MME of the present invention is, in an MME connected to a mobile communication system that performs distribution of broadcast data by an MBMS bearer service, from a BM-SC (Broadcast Multicast Service Center) to a mobile station device that is connected to a base station device, via an MBMS GW (MBMS Gateway) and an MME (Mobility Management Entity) for which an MBMS (Multimedia Broadcast/Multicast Service) bearer has been established, characterized in that,

the MBMS bearer context further includes a service identifier for identifying an MBMS bearer service,

the base station device transmits a session stop request associated with the MBMS bearer context to the MME when stopping the distribution of broadcast data associated with the MBMS bearer context, and

the MME transmits a session stop request associated with the MBMS bearer context to the MBMS GW when there is no mobile station device that is being connected via the MME and receiving distribution of broadcast data, in accordance with the session stop request transmitted from the base station device, and stops distribution of broadcast data to thereby release the MBMS bearer resources between the MME and the MBMS GW.

An GGSN of the present invention is, in an GGSN connected to a mobile communication system that performs distribution of broadcast data by an MBMS bearer service, from a BM-SC to a mobile station device that is connected to a base station device, via a GGSN and an SGSN for which an MBMS bearer has been established, characterized in that,

in the MBMS bearer service, information on the MBMS bearer established by assigning MBMS bearer resources is included in an MBMS bearer context,

the base station device transmits a session stop request associated with the MBMS bearer context to the SGSN when stopping the distribution of broadcast data associated with the MBMS bearer context,

the SGSN transmits a session stop request associated with the MBMS bearer context to the GGSN when stopping the distribution of broadcast data associated with the MBMS bearer context, in accordance with the session stop request transmitted from the base station device, and

the GGSN transmits a session stop request associated with the MBMS bearer context to the BM-SC when there is no mobile station device that is being connected via the GGSN and receiving distribution of broadcast data, in accordance with the session stop request transmitted from the SGSN, and stops distribution of broadcast data to thereby release the MBMS bearer resources between the GGSN and the BM-SC.

An MBMS GW of the present invention is, in an MBMS GW connected to a mobile communication system that performs distribution of broadcast data by an MBMS bearer service, from a BM-SC to a mobile station device that is connected to a base station device, via an MBMS GW and an MME for which an MBMS bearer has been established, characterized in that,

the MBMS bearer context further includes a service identifier for identifying an MBMS bearer service,

the base station device transmits a session stop request associated with the MBMS bearer context to the MME when stopping the distribution of broadcast data associated with the MBMS bearer context,

the MME transmits a session stop request associated with the MBMS bearer context to the MBMS GW when stopping the distribution of broadcast data associated with the MBMS bearer context, in accordance with the session stop request transmitted from the base station device, and

the MBMS GW transmits a session stop request associated with the MBMS bearer context to the BM-SC when there is no mobile station device that is being connected via the MBMS GW and receiving distribution of broadcast data, in accordance with the session stop request transmitted from the MME, and stops distribution of broadcast data to thereby release the MBMS bearer resources between the MBMS GW and the BM-SC.

A mobile communication method of the present invention is, in a mobile communication method for a mobile communication system that performs distribution of broadcast data by an MBMS bearer service, from a BM-SC to a mobile station device that is connected to a base station device, via a GGSN and an SGSN for which an MBMS bearer has been established, characterized in that,

in the MBMS bearer service, information on the MBMS bearer established by assigning MBMS bearer resources is included in an MBMS bearer context,

the base station device transmits a session stop request associated with the MBMS bearer context to the SGSN when stopping the distribution of broadcast data associated with the MBMS bearer context,

the SGSN transmits a session stop request associated with the MBMS bearer context to the GGSN when stopping the distribution of broadcast data associated with the MBMS bearer context, in accordance with the session stop request transmitted from the base station device, and

the GGSN transmits a session stop request associated with the MBMS bearer context to the BM-SC when there is no mobile station device that is being connected via the GGSN and receiving distribution of broadcast data, in accordance with the session stop request transmitted from the SGSN, and stops distribution of broadcast data.

A mobile communication method of the present invention is, in a mobile communication method in a mobile communication system that performs distribution of broadcast data by an MBMS bearer service, from a BM-SC to a mobile station device that is connected to a base station device, via an MBMS GW and an MME for which an MBMS bearer has been established, characterized in that,

the base station device transmits a session stop request associated with the MBMS bearer context to the MME when stopping the distribution of broadcast data associated with the MBMS bearer context,

the MME transmits a session stop request associated with the MBMS bearer context to the MBMS GW when stopping the distribution of broadcast data associated with the MBMS bearer context, in accordance with the session stop request transmitted from the base station device, and

the MBMS GW transmits a session stop request associated with the MBMS bearer context to the BM-SC when there is no mobile station device that is being connected via the MBMS GW and receiving distribution of broadcast data, in accordance with the session stop request transmitted from the MME, and stops distribution of broadcast data.

### Effect of the Invention

According to the present invention, in a mobile communication system that performs distribution of broadcast data by an MBMS bearer service, from a BM-SC to a mobile station device that is connected to a base station device, via a GGSN and an SGSN for which an MBMS bearer has been established, the base station device transmits a session stop request associated with the MBMS bearer context to the SGSN when stopping the distribution of broadcast data associated with the MBMS bearer context, and stops distribution of broadcast data to thereby release the MBMS bearer resources between the base station device and the SGSN.

Also, according to the present invention, in a mobile communication system that performs distribution of broadcast data by an MBMS bearer service, from a BM-SC to a mobile station device that is connected to a base station device, via an MBMS GW and an MME for which an MBMS bearer has been established, the base station device transmits a session stop request associated with the MBMS bearer context to the MME and requests the MBMS GW to stop the session when stopping the distribution of broadcast data associated with the MBMS bearer context, and stops distribution of broadcast data to thereby release the MBMS bearer resources between the base station device and the MBMS GW.

Thus, though conventionally, only the BM-SC (broadcast data distributing device) can initiatively perform a temporary suspension of a session while it has been impossible for a base station device to stop a session even if the base station device can check the necessity of mobile station devices to receive data and detect that data distribution is unnecessary, it is possible for the base station device initiatively perform a session stop procedure based on the result of determination on whether or not a mobile station device needs reception.

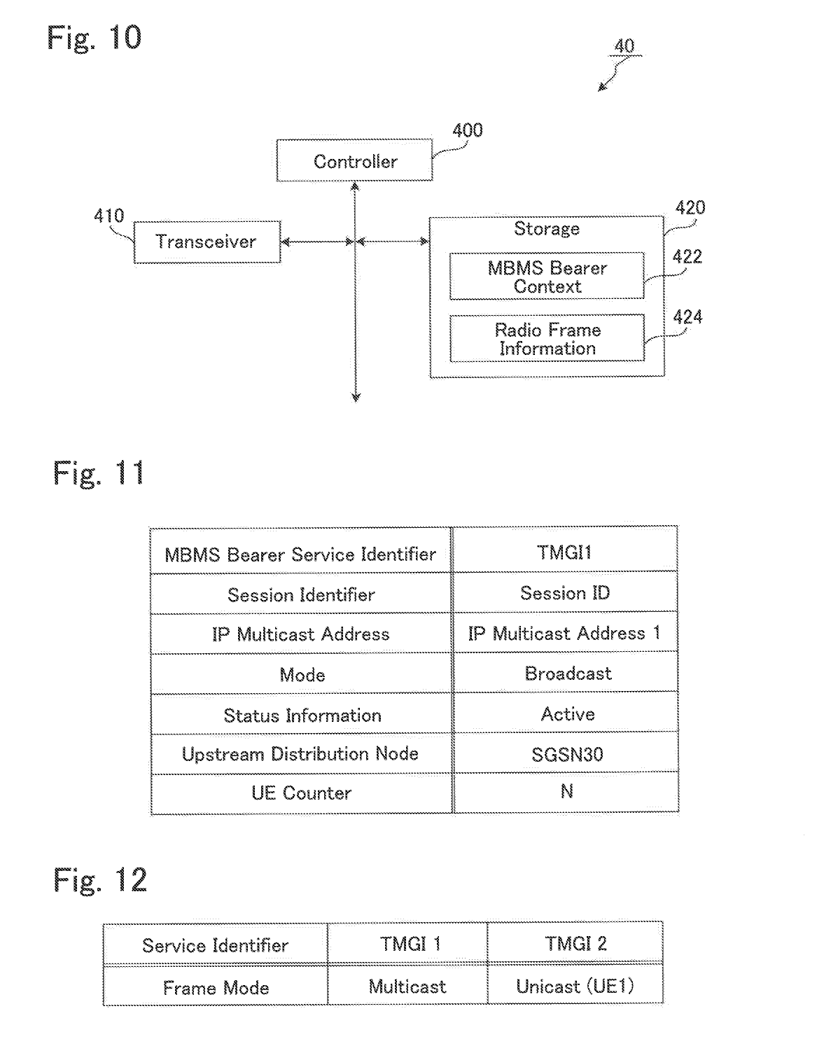

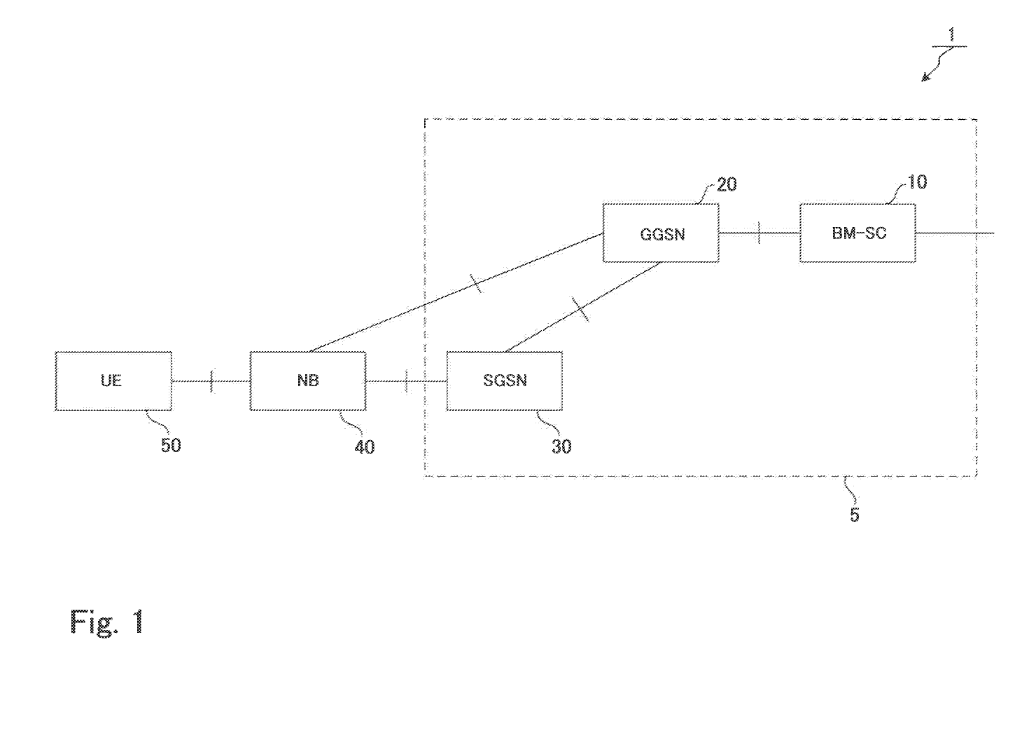

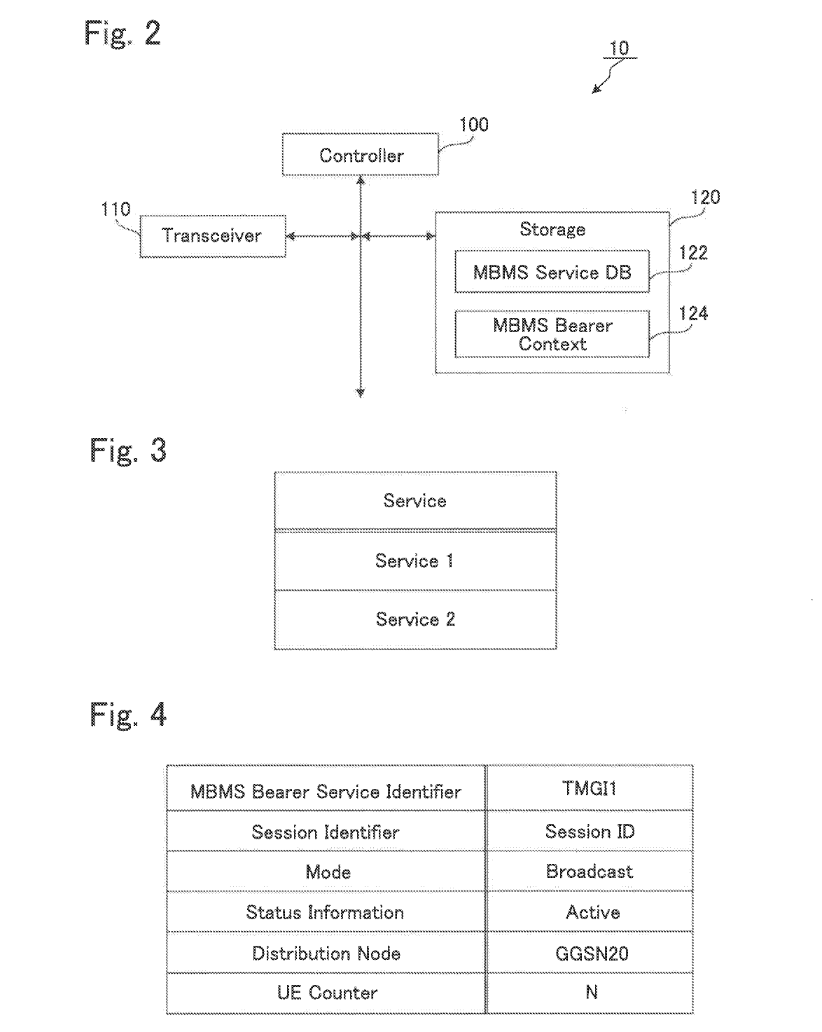

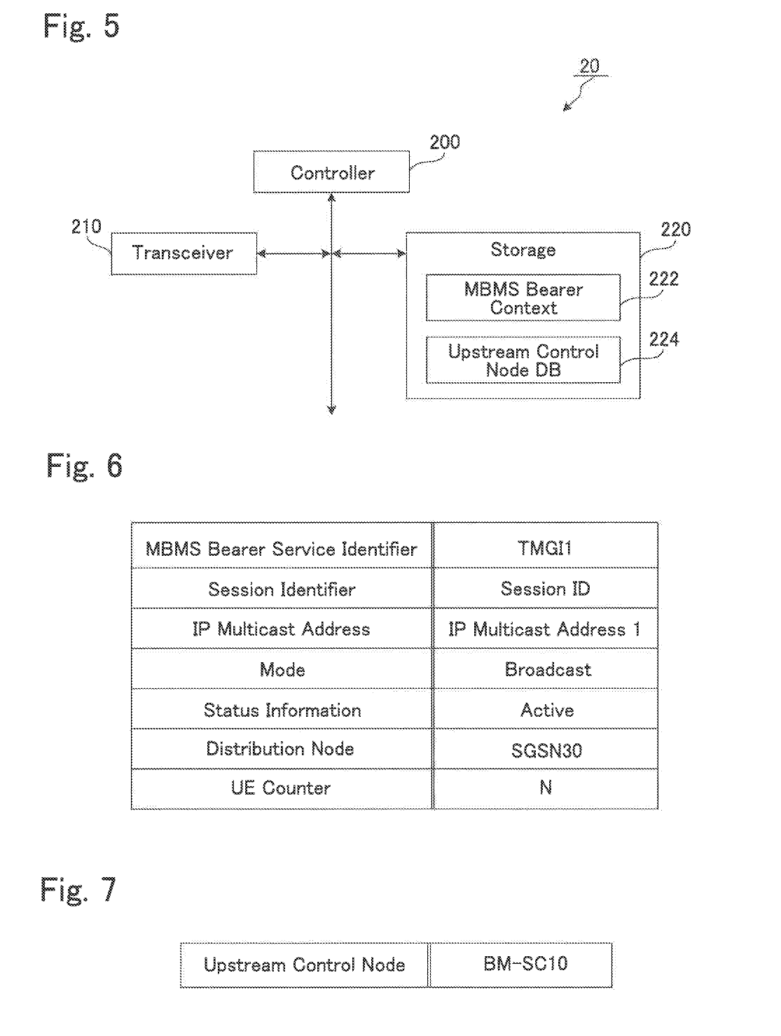

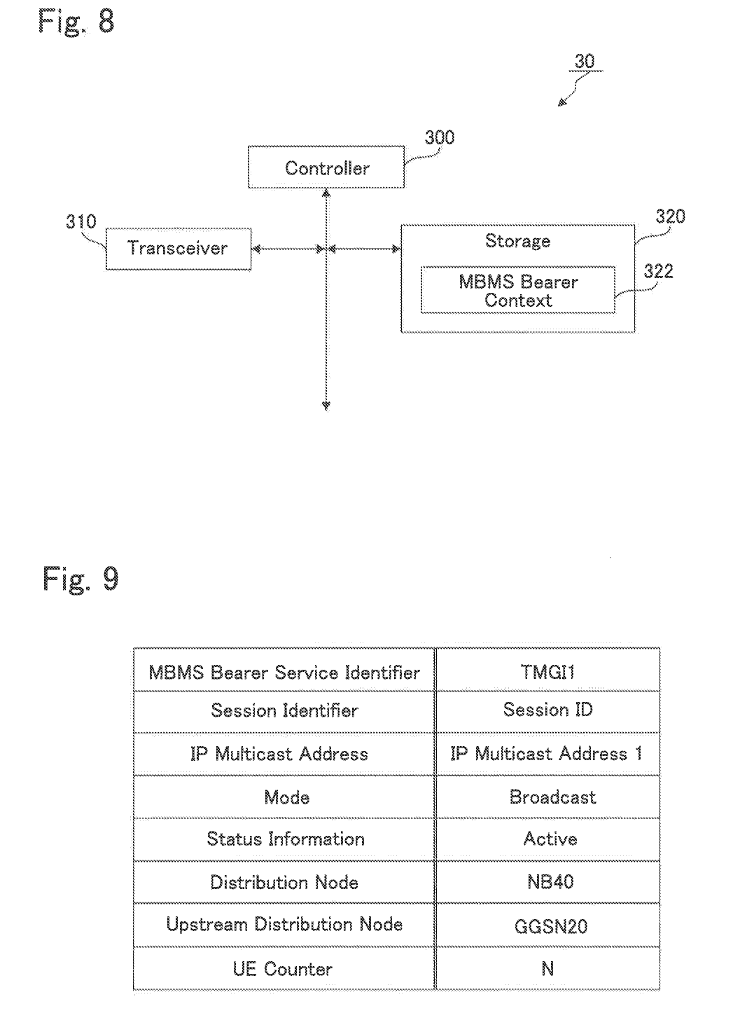

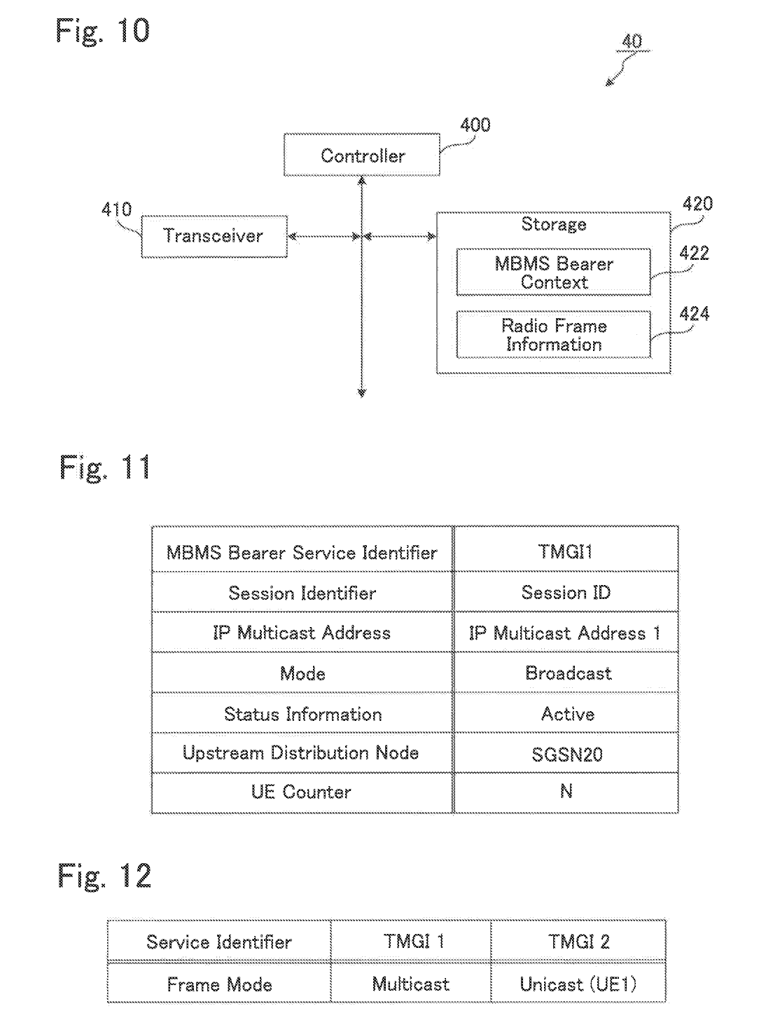

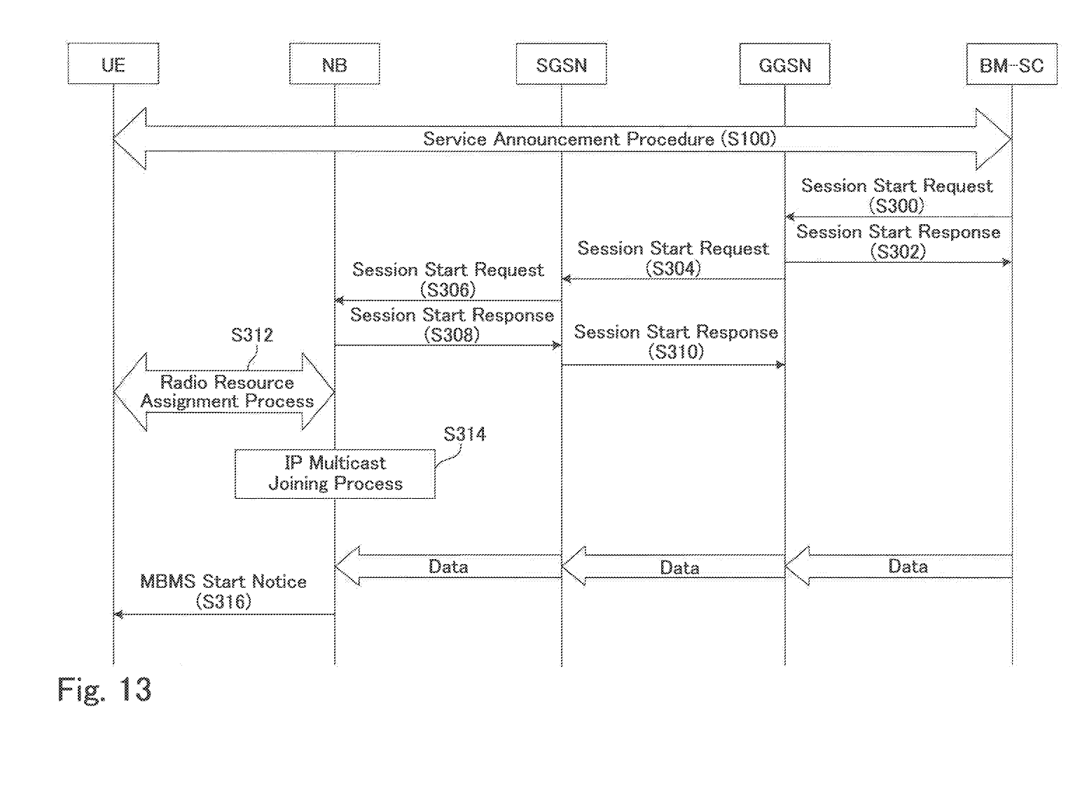

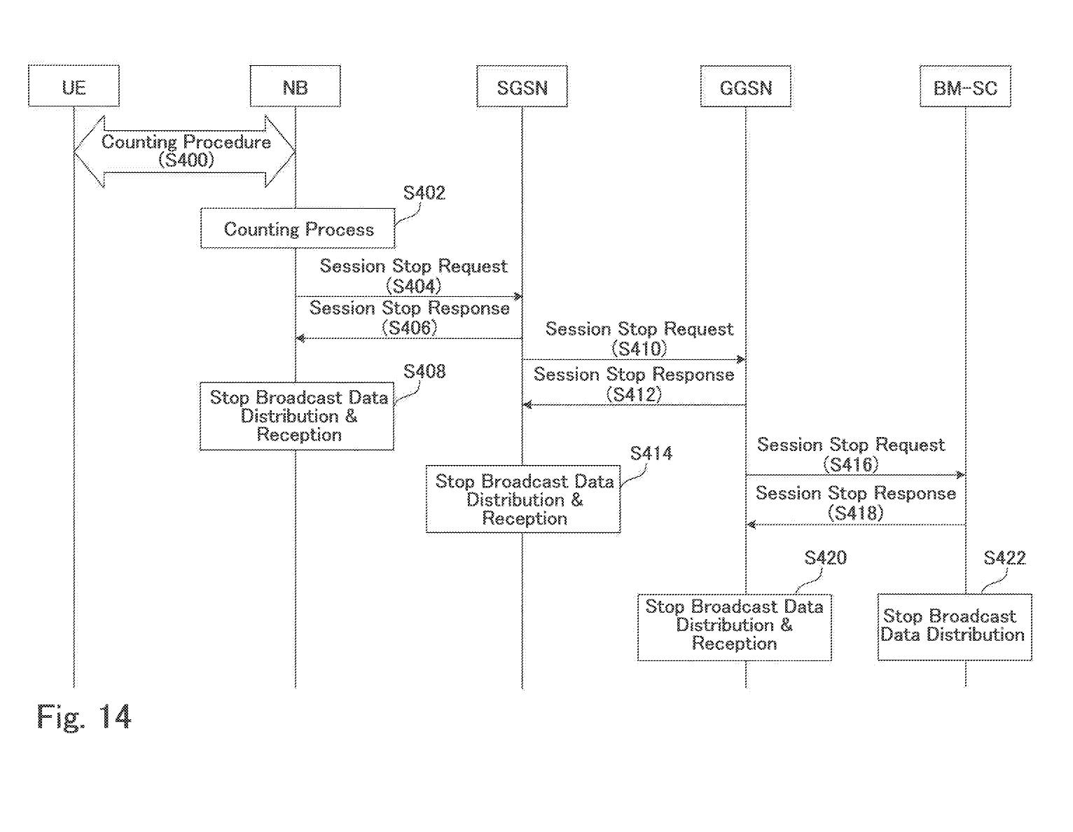

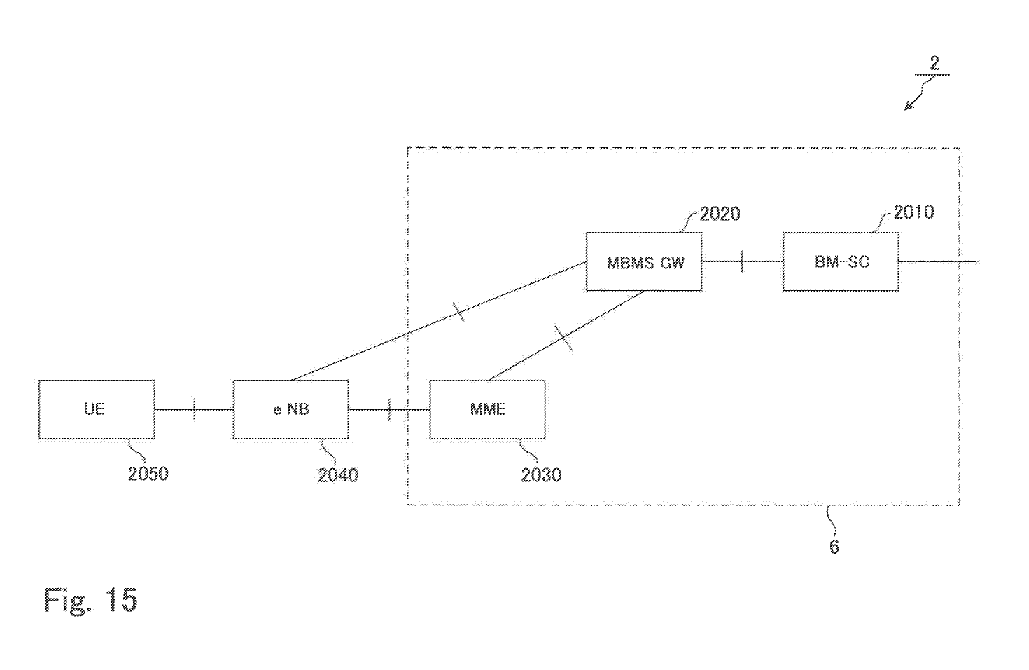

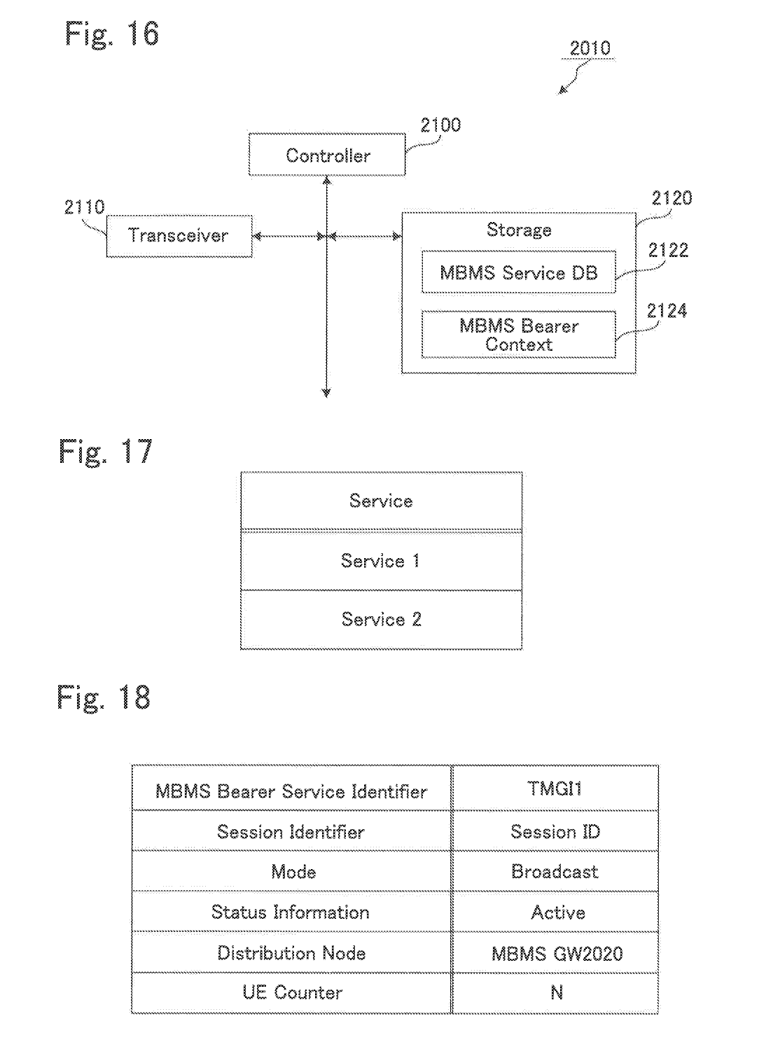

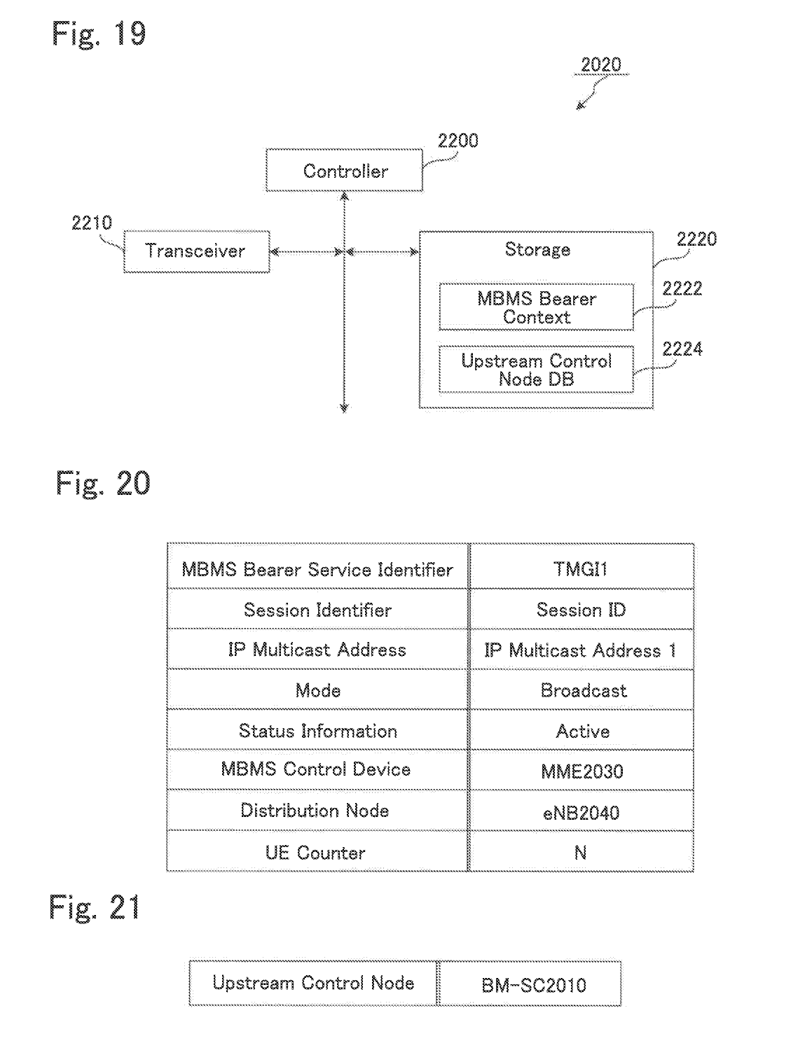

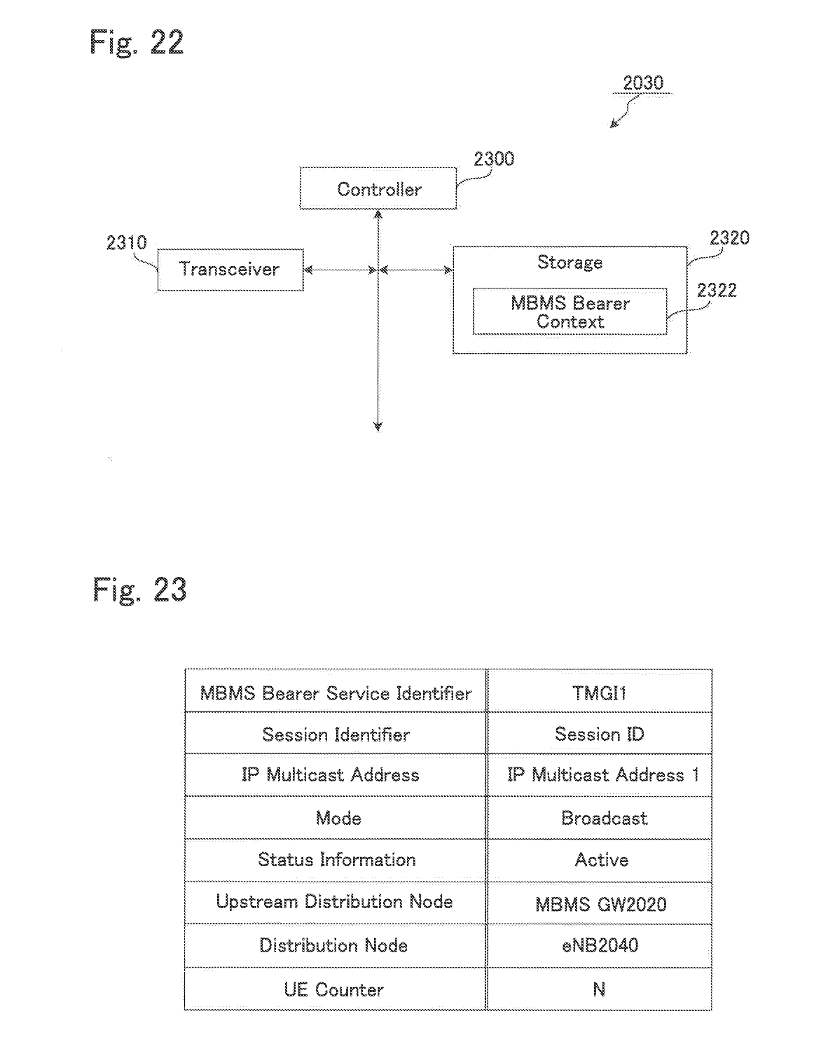

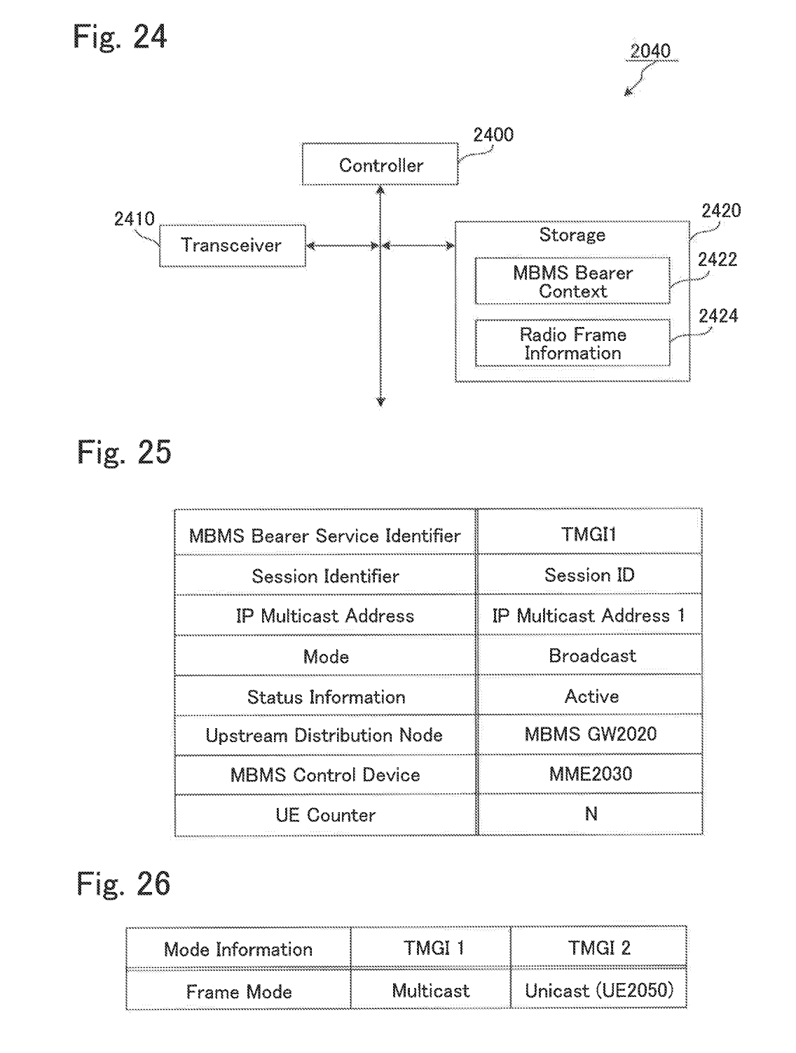

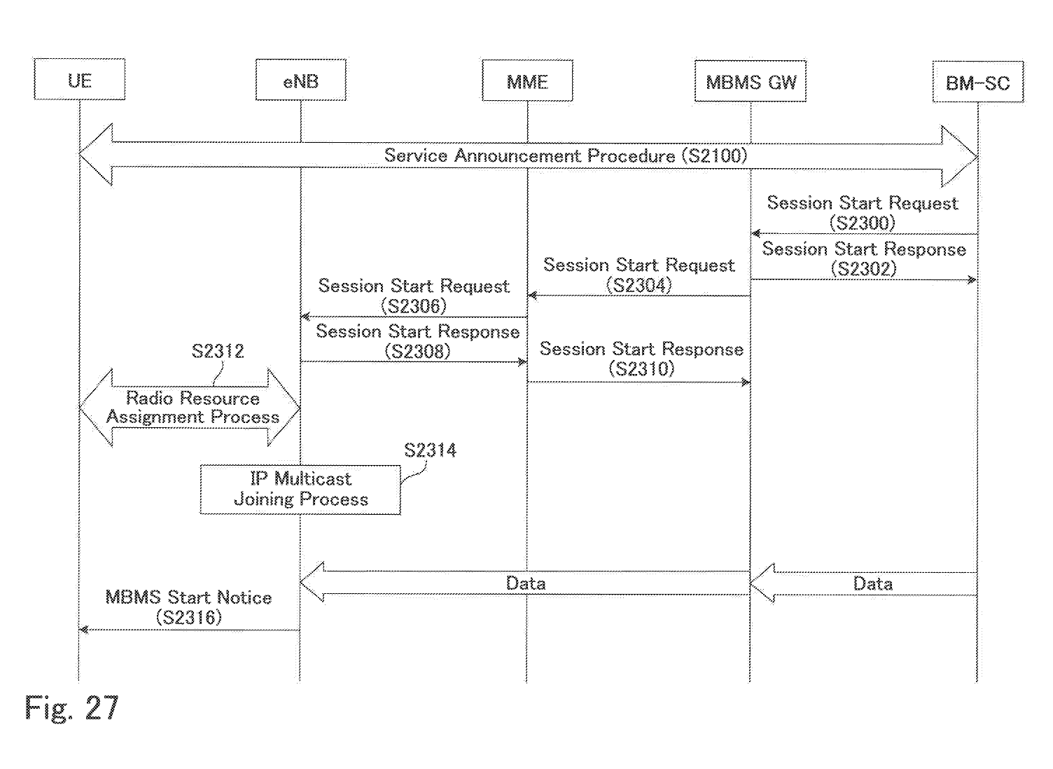

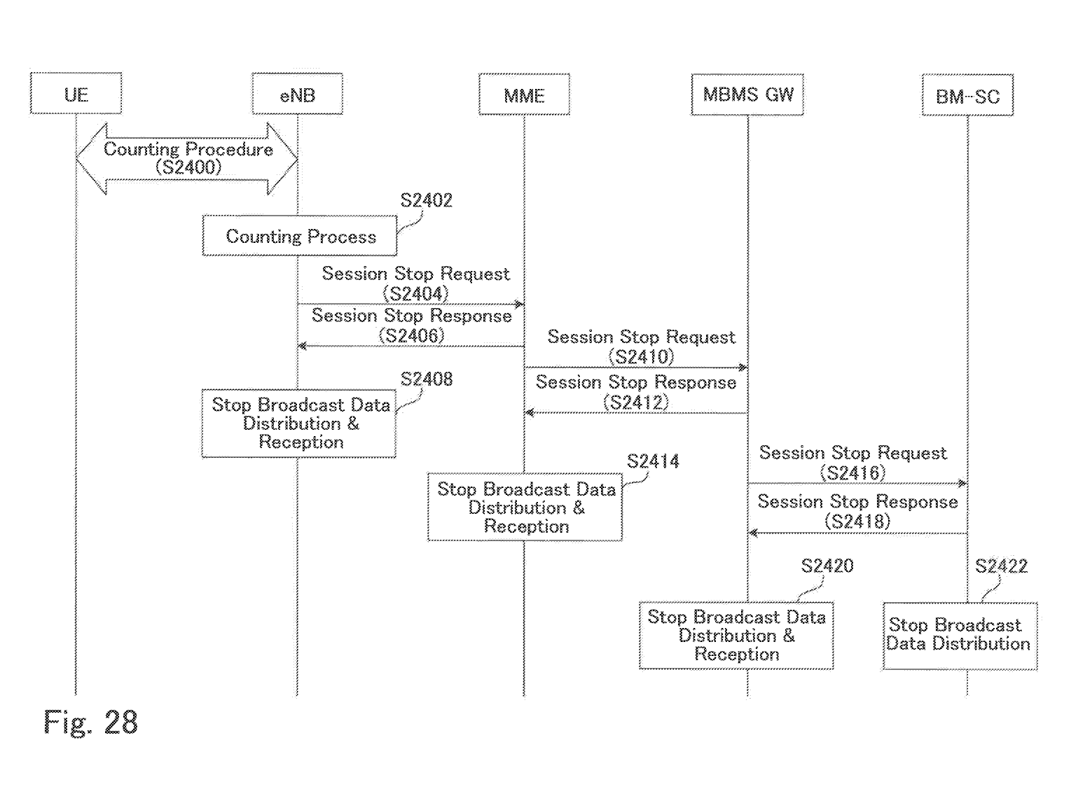

### BRIEF DESCRIPTION OF DRAWINGS

[FIG. 1] is a diagram for illustrating the scheme of a mobile communication system in the present embodiment.

[FIG. 2] is a diagram for illustrating a functional configuration of a BM-SC in the present embodiment.

[FIG. 3] is example of a data configuration of an MBMS service DB stored in a BM-SC in the present embodiment.

[FIG. 4] is an example of a data configuration of an MBMS bearer context stored in a BM-SC in the present embodiment.

[FIG. 5] is a diagram for illustrating a functional configuration of a GGSN in the present embodiment.

[FIG. 6] is an example of a data configuration of an MBMS bearer context stored in a GGSN in the present embodiment.

[FIG. 7] is an example of a data configuration of an upstream control node DB stored in a GGSN in the present embodiment.

[FIG. 8] is a diagram for illustrating a functional configuration of an SGSN in the present embodiment.

[FIG. 9] is an example of a data configuration of an MBMS bearer context stored in SGSN in the present embodiment.

[FIG. 10] is a diagram for illustrating a functional configuration of an NB in the present embodiment.

[FIG. 11] is an example of a data configuration of an MBMS bearer context stored in an NB in the present embodiment.

[FIG. 12] is an example of a data configuration of radio frame information stored in an NB in the present embodiment.

[FIG. 13] is a diagram for illustrating the flow of procedure processing in the present embodiment.

[FIG. 14] is a diagram for illustrating the flow of procedure processing in the present embodiment.

[FIG. 15] is a diagram for illustrating the scheme of a mobile communication system in the present embodiment.

[FIG. 16] is a diagram for illustrating a functional configuration of a BM-SC in the present embodiment.

[FIG. 17] is an example of a data configuration of an MBMS service DB stored in a BM-SC in the present embodiment.

[FIG. 18] is an example of a data configuration of an MBMS bearer context stored in a BM-SC in the present embodiment.

[FIG. 19] is a diagram for illustrating a functional configuration of an MBMS GW in the present embodiment.

[FIG. 20] is an example of a data configuration of an MBMS bearer context stored in an MBMS GW in the present embodiment.

[FIG. 21] is an example of a data configuration of an upstream control node DB stored in an MBMS GW in the present embodiment.

[FIG. 22] is a diagram for illustrating a functional configuration of an MME in the present embodiment.

[FIG. 23] is an example of a data configuration of an MBMS bearer context stored in an MME in the present embodiment.

[FIG. 24] is a diagram for illustrating a functional configuration of an eNB in the present embodiment.

[FIG. 25] is an example of a data configuration of an MBMS bearer context stored in an eNB in the present embodiment.

[FIG. 26] is an example of a data configuration of radio frame information stored in an eNB in the present embodiment.

[FIG. 27] is a diagram for illustrating the flow of procedure processing in the present embodiment.

[FIG. 28] is a diagram for illustrating the flow of procedure processing in the present embodiment.

### MODE FOR CARRYING OUT THE INVENTION

Now, the best mode for carrying out the present invention will be described with reference to the drawings. Here, the present embodiment will be described in detail using drawings, taking an example of an embodiment of a mobile communication system when the present invention is applied.

### 1. The First Embodiment

To begin with, the first embodiment to which the present invention is applied will be described with reference to drawings.

[1.1 System Configuration]

FIG. 1 is a diagram for illustrating the scheme of a mobile communication system 1 in a case to which the present invention is applied. Mobile communication system 1 is comprised of a BM-SC (Broadcast Multicast Service Center) 10 as a broadcast-multicast service center, a core network 5 including a GGSN (Gateway GPRS Support Node) 20 as a gateway device and an SGSN (Serving GPRS Support Node) as a service control device, an NB 40 as a base station device and a UE 50 as a mobile station device.

Connected to core network 5 is NB 40, to which UE 50 is connectable. Specifically, GGSN 20 is connected to the downstream side of BM-SC 10. NB 40 is connected to the downstream side of GGSN 20 directly or by way of SGSN 30. Further, UE 50 is connected to the downstream side of NB 40.

Here, in FIG. 1 of the present embodiment, for description convenience, only one device is shown for each component device though multiple devices are connected. For example, mobile communication system 1 includes one or multiple GGSNs, which each have one or multiple SGSNs and NBs connected on the downstream side thereof. Further, one or multiple UEs can be connected to each NB.

[1.2 Device Configuration]

Next, the functional configuration of each device will be described using drawings.

[1.2.1 BM-SC]

The functional configuration of BM-SC 10 will be described with reference to FIG. 2. BM-SC 10 includes a controller 100 to which a transceiver 110 and a storage 120 are connected.

Transceiver 110 is an interface unit connected to a network, and is connected to, for example GGSN 20 via the network.

Storage 120 is a functional unit in which various programs, and various data, necessary for BM-SC 10 to operate are stored. Storage 120 may include a semiconductor memory, HDD (Hard Disk Drive) and the like. In the present embodiment, an MBMS service DB 122 and an MBMS bearer context 124 are stored therein.

MBMS service DB 122 is a DB for storing a service identifier of distributed data for each MBMS bearer service in order to manage distributable MBMS bearer services. FIG. 3 shows one example of a data configuration of MBMS service DB 122.

Here, various kinds of identifiers may be used as the service identifier. For example, used are:

(1) TMGI (Temporary Mobile Group Identity) that identifies an MBMS bearer context,
(2) other identifiers (e.g., an identifier which is assigned by an operator implementing a service operation by using BM-SC 10), and the like. The present embodiment will be described on the assumption that (1) TMGI is used.

Specifically used is TMGI that identifies an MBMS bearer context created for each service when broadcast data is distributed by an MBMS bearer service. Though TMGI is temporarily assigned subscriber ID information that is used in conventional mobile phone services, in MBMS this is used as the information for identifying the MBMS bearer service.

MBMS bearer context 124 is management information, created for each MBMS bearer service and relating to the MBMS bearer which is established to deliver broadcast data. FIG. 4 shows one example of a data configuration of MBMS bearer context 124.

Specifically, the MBMS bearer context includes an MBMS bearer service identifier such as TMGI etc. (e.g., “TGMI1”), the identifier of a session to be established for distribution (e.g., “session ID”), the mode for discriminating either multicast mode or broadcast mode (e.g., “broadcast mode”), status information for managing the state of the MBMS bearer, being either active or suspended (e.g., “active”), a distribution node to which data is delivered (e.g., “GGSN 20”), and a UE counter (e.g., “N”).

Herein, as the distribution node, information for identifying the distribution node is stored. For example an IP address (the IP address of GGSN 20 in the case of FIG. 4) is stored. Multiple distribution nodes can also be stored.

The UE counter shows the number of terminals that receive broadcast data of the MBMS bearer service. This is based on the number counted by the counting function of the base station device, or the number of terminals through which users are actually receiving content, or the like.

Further, BM-SC 10 stores a different UE counter for each GGSN so as to be able to count the numbers of UEs when information on multiple GGSNs as distribution nodes is stored in MBMS bearer context 124. Accordingly, BM-SC 10 can store the number of terminals that are using the broadcast data delivered to GGSN 20.

[1.2.2 GGSN]

Next, the functional configuration of GGSN 20 will be described with reference to FIG. 5. GGSN 20 includes a controller 200 to which a transceiver 210 and a storage 220 are connected.

Transceiver 210 is an interface unit connected to a network, and is connected to, for example BM-SC 10, SGSN 30 and NB 40 via the network.

Storage 220 is a functional unit in which various programs, and various data, necessary for GGSN 20 to operate are stored. Storage 220 may include a semiconductor memory, HDD (Hard Disk Drive) and the like. In the present embodiment, an MBMS bearer context 222 and an upstream control node DB 224 are stored therein.

MBMS bearer context 222 is management information, created for each MBMS bearer service and necessary for delivering broadcast data. FIG. 6 shows one example of a data configuration of MBMS bearer context 222.

Specifically, the MBMS bearer context includes an MBMS bearer service identifier such as TMGI etc. (e.g., “TGMI 1”), the identifier of a session to be established for distribution (e.g., “session ID”), an IP multicast address for performing IP multicast communication (e.g., “IP multicast address 1”), the mode for discriminating either multicast mode or broadcast mode (e.g., “broadcast”), status information for managing the state of the MBMS bearer, being either active or suspended (e.g., “active”), a distribution node to which data is delivered (e.g., “SGSN 30”), and a UE counter (e.g., “N”).

Herein, as the distribution node, information for identifying the distribution node is stored. For example an IP address (the IP address of SGSN 30 in the case of FIG. 6) is stored. Multiple distribution nodes may also be stored.

The IP multicast address is stored for each MBMS bearer service for which an MBMS bearer context is created.

The UE counter shows the number of terminals that receive broadcast data of the MBMS bearer service. This is based on the number counted by the counting function of the base station device, or the number of terminals through which users are actually receiving content, or the like.

Further, GGSN 20 stores a different UE counter for each SGSN so as to be able to count the numbers of UEs when information on multiple SGSNs as distribution nodes is stored in MBMS bearer context 222. Accordingly, GGSN 20 can store the number of terminals that are using the broadcast data delivered to SGSN 30.

Upstream control node DB 224 is a DB for storing information for identifying upstream broadcast data node delivering device. FIG. 7 shows one example of a configuration of upstream control node DB 224. In the present embodiment, information on BM-SC 10 is stored. For example, the IP address of BM-SC 10 is stored.

Upstream control node DB 224 stores one upstream control node (BM-SC 10) as shown in FIG. 7. Alternatively, multiple upstream control nodes (BM-SCs) corresponding to different services may be stored. In this case, each node is stored in association with an MBMS bearer context that can be distinguished by TMGI or the like.

[1.2.3 SGSN]

Subsequently, the functional configuration of SGSN 30 will be described with reference to FIG. 8. SGSN 30 includes a controller 300 to which a transceiver 310 and a storage 320 are connected.

Transceiver 310 is an interface unit connected to a network, and is connected to, for example GGSN 20 and NB 40 via the network.

Storage 320 is a functional unit in which various programs, and various data, necessary for SGSN 30 to operate are stored. Storage 320 may include a semiconductor memory, HDD (Hard Disk Drive) and the like. In the present embodiment, an MBMS bearer context 322 is stored therein.

MBMS bearer context 322 is management information, created for each MBMS bearer service and necessary for delivering broadcast data. FIG. 9 shows one example of a data configuration of MBMS bearer context 322.

Specifically, the MBMS bearer context includes an MBMS bearer service identifier such as TMGI etc. (e.g., “TGMI1”), the identifier of a session to be established for delivery (e.g., “session ID”), an IP multicast address for performing IP multicast communication (e.g., “IP multicast address 1”), the mode for discriminating either multicast mode or broadcast mode (e.g., “broadcast”), status information for managing the state of the MBMS bearer, being either active or suspended (e.g., “active”), a distribution node to which data is delivered (e.g., “NB 40”), the superior distribution node to be the distribution node in the higher rank (e.g., “GGSN 20”) and a UE counter (e.g., “N”).

Herein, as the distribution node and superior distribution node, information for identifying each node is stored. For example, IP addresses (the IP addresses of NB 40 and GGSN 20 in the case of FIG. 9) are stored. Multiple distribution nodes may also be stored.

The IP multicast address is stored for each MBMS bearer service for which an MBMS bearer context is created.

The UE counter shows the number of terminals that receive broadcast data of the MBMS bearer service. This is based on the number counted by the counting function of the base station device, or the number of terminals through which users are actually receiving content, or the like.

Further, SGSN 30 stores a different UE counter for each NB so as to be able to count the numbers of UEs when information on multiple NBs as the distribution node is stored in MBMS bearer context 322. Accordingly, SGSN 30 can store the number of terminals that are using the broadcast data delivered to NB 40.

[1.2.4 NB]

Subsequently, the functional configuration of NB 40 will be described with reference to FIG. 10. NB 40 includes a controller 400 to which a transceiver 410 and a storage 420 are connected.

Transceiver 410 is an interface unit connected to a network, and is connected to, for example GGSN 20 and SGSN 30, and can be connected to UE 50, via the network.

Storage 420 is a functional unit in which various programs, and various data, necessary for NB 40 to operate are stored. Storage 420 may include a semiconductor memory, HDD (Hard Disk Drive) and the like. In the present embodiment, an MBMS bearer context 422 and a radio frame information 424 are stored therein.

MBMS bearer context 422 is management information, created for each MBMS bearer service and necessary for delivering broadcast data. FIG. 11 shows one example of a data configuration of MBMS bearer context 422.

Specifically, the MBMS bearer context includes an MBMS bearer service identifier such as TMGI etc. (e.g., “TGMI1”), the identifier of a session to be established for delivery (e.g., “session ID”), an IP multicast address for performing IP multicast communication (e.g., “IP multicast address 1”), the mode for discriminating either multicast mode or broadcast mode (e.g., “broadcast”), status information for managing the state of the MBMS bearer, being either active or suspended (e.g., “active”), a superior distribution node to be the distribution node in the higher rank (e.g., “SGSN 30”) and a UE counter (e.g., “N”).

Herein, as the superior distribution node, information for identifying the node is stored. For example, an IP address (the IP address of SGSN 30 in the case of FIG. 11) is stored.

The IP multicast address is stored for each MBMS bearer service for which an MBMS bearer context is created.

The UE counter shows the number of terminals that receive broadcast data of the MBMS bearer service. This is based on the number counted by the counting function of the base station device, or the number of terminals through which users are actually receiving content, or the like.

As radio frame information 424, information on the radio frame which is used by NB 40 to perform transmission to UE 50 in the radio section is stored for each MBMS bearer service. FIG. 12 shows an example of a data configuration of radio frame information 424.

Specifically, for each identifier for identifying an MBMS bearer service (for each TMGI, for example), mode information representing either multicast mode or unicast mode (e.g., “frame mode”) is stored. Further, in the case of unicast mode, ID information such as the IMSI (International Mobile Subscriber Identity) of the target UE 50 of frame delivery is stored. Here, a plurality of target UEs (ID information) of frame delivery may be stored.

[1.3 Procedural Processing]

Next, the procedural processing of mobile communication system 1 in the present embodiment will be described using drawings.

[1.3.1 Service Announcement Procedure]

To begin with, BM-SC 10 performs a service announcement procedure to UE 50, as shown in FIG. 13. BM-SC 10 notifies UE 50 of distributable services (S100). From this notice, UE 50 detects the broadcast services.

BM-SC 10 notifies the possibility of distribution of services managed by MBMS service DB 122 to UE 50 by giving notice of service identifiers. Further, information for explaining the services, such as program titles, content titles, start times of distribution, etc. may be additionally notified.

Here, various kinds of identifiers may be used as the service identifier. For example,

### (1) TMGI,

(2) other identifiers (e.g., other identifiers that are designated the operator and can be used to discriminate MBMS bearer services), and the like can be used. The present embodiment will be described on the assumption that (1) TMGI is used.

Various specific methods can be considered to give notice. For example, SMS (Short Message Service) or the like may be used to give notice to distributable UEs 50 that are registered in advance or to unspecified large number of UEs 50, or information may be put up on a bulletin board on the web so that UE 50 can access the web server to get the information.

[1.3.2 Session Start Procedure]

A session start procedure to be executed next will be described with reference to FIG. 13. The session start procedure sets up an MBMS bearer and establishes a communication path.

BM-SC 10 selects a service and transmits a session start request to GGSN 20 (S300). In this step, a TMGI for designating a service and a session identifier for identifying the session are created, and these are included in the session start request to be transmitted. Thus, a session start procedure starts.

Further, the BM-SC creates MBMS bearer context 124, entering the TMGI and the session identifier into the MBMB bearer context 124 and setting the status information to be “active”.

As the distribution node, information on GGSN 20 is entered. A plurality of GGSNs can be registered as the distribution node.

The recipient node (GGSN) to be registered may be entered in advance by the operator, or a list of distribution nodes (GGSNs 20 etc.) for every MBMS service area has been registered, so that the identifier of the MBMS service area is included in the session start request to be transmitted. Then, a corresponding GGSN can be selected based on the transmitted MBMS service area identifier.

Here, the timing at which BM-SC 10 starts the session start procedure may be triggered at the moment the aforementioned service announcement procedure is completed, or the session start procedure may be started even before its completion, at an any timing in accordance with the operator's policy or the like.

The session start request is transmitted to all the GGSNs registered as the distribution node in MBMS bearer context 124.

GGSN 20 receives the session start request and transmits a session start response to BM-SC 10 to reply (S302). Further, the GGSN creates MBMS bearer context 222, entering the TMGI and the session identifier in the context and setting the status information to be “active”.

As the distribution node, information on SGSN 30 is registered. A plurality of SGSNs can be registered as the distribution node.

SGSN 30, the distribution node to be registered may be entered in advance by the operator, or a list of distribution nodes (SGSNs 30 etc.) for every MBMS service area has been registered so that a corresponding SGSN 30 can be selected based on the MBMS service area identifier included in the session start request transmitted from BM-SC 10.

The procedure described heretofore establishes an MBMS bearer as the delivery path that assures communication quality for broadcast data delivery between BM-SC 10 and GGSN 20.

Further, in order to enable the transmission by the MBMS bearer to achieve IP multicast communication, an IP multicast address is assigned to the service and registered in MBMS bearer context 222.

GGSN 20 transmits a session start request to SGSN 30 that is registered as the distribution node in MBMS bearer context 222 (S304). In order to designate a service, the session start request includes the TMGI, session identifier and IP multicast address.

The session start request is transmitted to all the SGSNs registered as the distribution node in MBMS bearer context 222.

SGSN 30 receives the session start request and transmits a session start response to GGSN 20 to reply (S310). Further, the SGSN creates MBMS bearer context 322, entering the TMGI, the session identifier and the IP multicast address in the context and setting the status information to be “active”.

As the distribution node, information on NB 40 is registered. A plurality of NBs can be registered as the distribution node.

Here, NB 40, the distribution node to be registered may be entered in advance by the operator, or a list of distribution nodes (NBs 40 etc.) for every MBMS service area has been registered so that a corresponding NB can be selected based on the MBMS service area identifier included in the session start request transmitted from GGSN 20.

Further, information on GGSN 20, the superior distribution node to which the request was sent is registered (the IP address in the present embodiment).

The procedure described heretofore establishes an MBMS bearer as the delivery path that assures communication quality for broadcast data delivery between GGSN 20 and SGSN 30.

SGSN 30 transmits a session start request to NB 40 that is registered as the distribution node in MBMS bearer context 322 (S306). The session start request includes the TMGI, session identifier and IP multicast address.

The session start request is also transmitted to all the NBs registered as the distribution node in MBMS bearer context 322.

NB 40 receives the session start request and transmits a session start response to SGSN 30 to reply (S308). Further, the NB creates MBMS bearer context 422, entering the TMGI, the session identifier and the IP multicast address in the context and setting the status information to be “active”.

Further, information on SGSN 30, the superior distribution node to which the request was sent is registered.

The procedure described heretofore establishes an MBMS bearer as the delivery path that assures communication quality for broadcast data delivery between SGSN 30 and NB 40.

At this point, NB 40 performs an IP multicast joining process (S314). NB 40, referring to MBMS bearer context 422, makes a join request using the IP multicast address corresponding to the service. Specifically, in the case of IPv4 communication, the NB sends an IGMP Membership Report message. In the case of IPv6, the NB sends an MLD Membership Report.

As a result, IP multicast packets are delivered through the MBMS bearer established between BM-SC 10, GGSN 20, SGSN 30 and NB 40. Broadcast data is transmitted from BM-SC 10 to NB 40 by IP multicast.

Further, NB 40 performs an assignment process of radio resources for transmission to UE 50 and registers the information for delivery into radio frame information 424 (S312). Specifically, mode information on which mode, multicast mode or unicast mode is used as the radio frame is registered for every service identifier. As the service identifier, TMGI can be used.

In a case of transmission in multicast mode, the frame does not need to retain UE information because it is transmitted to unspecified large number of UEs. On the other hand, in the case of transmission in unicast mode, it is necessary to transmit radio frames to individual UEs. Therefore, in this case, IMSI is retained as UE information and registered as UE information for an activation procedure.

As a result of the service announcement procedure and session start procedure described heretofore, a communication path is established between UE 50 and BM-SC 10 so that data transmitted from BM-SC 10 can be delivered to NB 40.

Herein, though in the above example the service announcement procedure is performed first, then the session start procedure is performed, these procedures may be done in the reverse order.

At last, NB 40 sends an MBMS start notice to UE 50 (S316). The start notice to be sent should include the service identifier for identifying the service. Hereby, UE 50 starts reception of broadcast data.

Herein, various kinds of identifiers may be used as the service identifier. For example,

(1) the TMGI registered in MBMS bearer context 422,
(2) the session ID registered in MBMS bearer context 422
(3) other identifiers (e.g., an identifier that permits NB 40 and UE 50 to identify an MBMS bearer service) and the like can be used. In this embodiment, description will be made on the assumption that (1) TMGI is used. In the case of (3), the service identifier should be registered in association with MBMS bearer context 422.

When NB 40 does not notify MBMS start, BM-SC 10 notifies UE 50 by the service announcement procedure or the like. The notice can be given selectively in accordance with the operator's policy. Hereby, UE 50 starts reception of broadcast data.

Though the above example was described referring to the process when GGSN 20 receives a session start request, the same procedure as that for GGSN 20 is carried out when another GGSN receives a session start request from BM-SC 10.

Similarly, though the example as to the SGSN was described referring to the process when SGSN 30 receives a session start request, the same procedure as that of SGSN 30 is carried out when another SGSN receives a session start request from the GGSN.

Similarly, though the example as to the NB was described referring to a process when NB 40 receives a session start request, the same procedure as that of NB 40 is carried out when another NB receives a session start request from the SGSN.

Similarly, though the example as to the UE was described referring to the process when UE 50 receives a session start request, the same procedure as that of UE 50 is carried out when another UE receives a session start request from the NB.

Hereby, the broadcast data distributed by BM-SC 10 is delivered to the UE via multiple entities, GGSN, SGSN and NB in a top-down manner.

[1.3.3 Distribution Stop Procedure]

Next, a session stop procedure will be described with reference to FIG. 14. Though description will be made on an example in which the session stop procedure starts based on the result of the counting procedure at NB 40, the procedure can be started by NB 40, by any other start trigger than this.

To begin with, the counting procedure to be the trigger of a session stop procedure will be described. This procedure is proceeded between NB 40 and UE 50. NB 40 transmits to UE 50 being connected, a message with service identifiers to confirm whether a service is being received.

Herein, NB 40 sends the message for confirming whether a service is received or not, to the UEs 50 registered in radio frame information 424, but may transmit to all the UEs being connected.

Herein, various kinds of identifiers may be used as the service identifier. For example,

(1) the TMGI registered in MBMS bearer context 422,
(2) the session ID registered in MBMS bearer context 422,
(3) other identifiers (e.g., an identifier that permits NB 40 and UE 50 to identify an MBMS bearer service) and the like can be used. In this embodiment, description will be made on the assumption that (1) TMGI is used.

As receiving the message, UE 50 makes a reply including a service identifier, to NB 40.

Here, even if UE 50 has received an MBMS bearer service start notice and is ready for reception of broadcast data, the UE does not need to send a reply when reception is not necessary, for example, in a case where the application for receiving content is turned off and in other cases.

Herein, various kinds of identifiers may be used as the service identifier. For example,

(1) the TMGI registered in MBMS bearer context 422,
(2) the session ID registered in MBMS bearer context 422
(3) other identifiers (an identifier that permits NB 40 and UE 50 to identify an MBMS bearer service) and the like can be used. In this embodiment, description will be made on the assumption that (1) TMGI is used.

Hereby, NB 40 can acquire the number of UEs 50 that actually need to receive broadcast data. The obtained number of UEs 50 is registered in the UE counter of MBMS bearer context 422.

NB 40 may transmit the message for confirmation without including service identifiers. In this case, if UE 50 needs to receive a service, the UE makes a reply including its service identifier.

It is possible to select a service if service identifiers have been acquired from the service announcement procedure or by any other method and retained.

NB 40 after receiving the reply, identifies the MBMS bearer context from the service identifier and registers the number of UEs 50 that made a reply, into the UE counter. Thus, the counting procedure (S400) is completed.

NB 40 performs a counting process to confirm whether the UE counter of MBMS bearer context 422 is zero (S402). When the UE counter is zero, the NB determines to temporarily suspend the session. Accordingly, when detecting no UE 50 receiving for each service, the NB temporarily suspends the session of the service.

NB 40 transmits a session stop request including the TMGI registered in MBMS bearer context 422, the service identifier, the flow identifier and information on NB 40, to SGSN 30 (S404). The SGSN to which the request is transmitted is solved based on the SGSN information in MBMS bearer context 422. In the present embodiment, the request is transmitted to SGSN 30. Then, the status information of MBMS bearer context 422 is set to be “standby”.

Herein, when the UE counter is zero, the NB stops distribution and reception of the broadcast data corresponding to the service (S408).

Here, to stop reception, an IP multicast separation request may be transmitted. Specifically, in the case of IPv4 communication, an IGMP Membership Report message is sent. In the case of IPv6, an MLD Membership Report is sent. Hereby, distribution and reception of IP multicast packets are stopped. Stoppage of distribution and reception of IP multicast packets stops distribution and reception of broadcast data.

SGSN 30 receives the session stop request and sends a session stop response to NB 40 (S406).

Further, SGSN 30 sets the UE counter associated with NB 40 to zero, and stops distribution and reception of the broadcast data of the corresponding service for NB 40 (S414).

Here, to stop reception, an IP multicast separation request may be transmitted. Specifically, in the case of IPv4 communication, an IGMP Membership Report message is sent. In the case of IPv6, an MLD Membership Report is sent. Hereby, distribution and reception of IP multicast packets are stopped. Stoppage of distribution and reception of IP multicast packets stops distribution and reception of broadcast data.

Also, the entry of NB 40 is deleted from the distribution node in MBMS bearer context 322 or is checked with a mark indicating “suspended”.

Further, SGSN 30 releases the resources for the MBMS bearer between NB 40 and itself. In other words, SGSN 30 releases the resources of the MBMS bearer when delivery of broadcast data to NB 40 is stopped.

Herein, when SGSN 30 is not distributing the broadcast data to other NBs, the SGSN transmits a session stop request to GGSN 20 (S410). Whether or not there is any distribution of broadcast data to other NBs can be determined from the fact that there is no NB entry in the distribution node of MBMS bearer context 322 or from the fact that all the NBs are checked with a mark indicating “suspended”. The session stop request is included with the TMGI registered in MBMS bearer context 322, the session identifier and information on SGSN 30, and transmitted. In this case, the status information in MBMS bearer context 322 is set to be “standby”.

When other multiple NBs have been registered as the distribution node of MBMS bearer context 322 and flow distribution is in progress, the SGSN ends the session stop procedure without transmitting a session stop request to GGSN 20.

GGSN 20 receives the session stop request and sends a session stop response to SGSN 30 (S412).

Further, GGSN 20 sets the UE counter associated with SGSN 30 to zero, and stops distribution and reception of the broadcast data of the corresponding service for SGSN 30 (S420).

Here, to stop reception, an IP multicast separation request may be transmitted. Specifically, in the case of IPv4 communication, an IGMP Membership Report message is sent. In the case of IPv6, an MLD Membership Report is sent. Hereby, distribution and reception of IP multicast packets are stopped. Stoppage of distribution and reception of IP multicast packets stops distribution and reception of broadcast data.

Also, the entry of SGSN 30 is deleted from the distribution node of MBMS bearer context 222 or is checked with a mark indicating “suspended”.

Herein, when GGSN 20 is not distributing the broadcast data to other SGSN, the GGSN transmits a session stop request to BM-SC 10 (S416). Whether or not there is any distribution of broadcast data to other SGSNs can be determined from the fact that there is no SGSN entry in the distribution node of MBMS bearer context 222 or from the fact that all the SGSNs are checked with a mark indicating “suspended”. The session stop request is included with the TMGI registered in MBMS bearer context 222, the session identifier and information on GGSN 20, and transmitted.

Further, GGSN 20 releases the resources for the MBMS bearer between SGSN 30 and itself. In other words, GGSN 20 releases the resources of the MBMS bearer when delivery of broadcast data to SGSN 30 is stopped. In this case, the status information in MBMS bearer context 222 is set to be “standby”.

When other multiple SGSNs have been registered in the distribution node of MBMS bearer context 222 and flow distribution is in progress, the GGSN ends the session stop procedure without transmitting a session stop request to BM-SC 10.

BM-SC 10 receives the session stop request and sends a session stop response to GGSN 20(S418).

Further, BM-SC 10 releases the resources for the MBMS bearer between GGSN 20 and itself. In other words, BM-SC 10 releases the resources of the MBMS bearer when there is no broadcast data to be transmitted to GGSN 20.

The BM-SC stops delivery of the broadcast data of the corresponding service to GGSN 20 (S422).

The BM-SC 10 sets the UE counter associated with GGSN 20 to zero, and deletes the entry of GGSN 20 from the distribution node or checks the GGSN with a mark indicating “suspended”.

Further, when the entry of all the GGSNs 20 is deleted or checked with a mark indicating “suspended”, the status information in MBMS bearer context 124 is set to be “standby”.

Thus, the above procedure enables NB 40 to initiatively stop the session temporarily. Based on the counting procedure, the session stop procedure by NB 40 makes it possible to detect that delivery of the broadcast service for each MBMS bearer that can be identified by TMGI etc., is unnecessary.

Further, it is also possible to start when detecting no one receiving content as in a case where no one is watching or listening content because of the application etc., being off. Then, this detection can be used to trigger a session stop procedure.

Alternatively, the session stop procedure may be practiced only for broadcast services. The conventional MBMS bearer services include services in multicast mode and services in broadcast mode.

The broadcast mode service is a service that does not control subscriber information of UE 50 and does not need authorization for reception as described heretofore. In contrast, the multicast mode service is a service that requires an authorization procedure for each service in response to a join request of UE 50 to start distribution.

Accordingly, the delivery in multicast mode is a delivery to a particular UE, hence it should be presumed that there is a case in which temporal release of the MBMS bearer of a service and failure to recover resources at the restart of the service is not allowed. To deal with this, it is necessary to provide a method of temporarily suspending a service for broadcast mode only.

As a specific method of permitting the session stop procedure for broadcast services only, in the session start procedure described in FIG. 13, when BM-SC 10 creates a TMGI upon creation of MBMS bearer context 124 and notifies the TMGI to GGSN 20, SGSN 30 and NB 40, the mode is notified at the same time.

To control which mode, multicast mode or broadcast mode, should be notified, each service may be associated with a mode in advance and managed in MBMS service DB 122, or may be managed based on the presence or absence of the authorization step in the service activation procedure defined in the process of communication establishment in the multicast mode.

In this way, every device can know that the service to be registered is of broadcast mode and hold it in respective MBMS bearer contexts. Specifically, BM-SC 10 registers “broadcast” as the mode of MBMS bearer context 124, GGSN 20 registers “broadcast” as the mode of MBMS bearer context 222, SGSN 30 registers “broadcast” as the mode of MBMS bearer context 322, and NB 40 registers “broadcast” as the mode of MBMS bearer context 422.

Hereby, to determine stoppage of a session, each device can stop the session by referring to the MBMS bearer context when the service is in broadcast mode.

Specifically, when transmitting a broadcast session stop request (S404), NB 40 performs transmission of a stop request, release of the MBMS bearer and stoppage of distribution and reception of broadcast data when “broadcast” is registered as the mode in MBMS bearer context 422 (S408).

SGSN 30, when transmitting a broadcast session stop request (S410), performs transmission of a stop request, release of the MBMS bearer and stoppage of distribution and reception of broadcast data when “broadcast” is registered as the mode in MBMS bearer context 322 (S414).

GGSN 20, when transmitting a broadcast session stop request (S416), performs transmission of a stop request, release of the MBMS bearer and stoppage of distribution and reception of broadcast data when “broadcast” is registered as the mode in MBMS bearer context 222 (S420).

BM-SC 10, when transmitting a broadcast session stop request (S416), performs transmission of a stop request, release of the MBMS bearer and stoppage of distribution of broadcast data when “broadcast” is registered as the mode in MBMS bearer context 124 (S422).

Conventionally, only the sender of content data, i.e., BM-SC 10 can initiatively perform a temporary suspension of the session by detecting that there is no data to be transmitted, such as a case that there is no data to be transmitted in a certain period of time depending on the status of delivery data in BM-SC 10. Therefore, it has been impossible for NB 40 to stop the session even if NB 40 can check whether UE 50 needs reception or not and can detect that data distribution is unnecessary. The procedure of the present embodiment makes it possible for NB 40 to initiatively perform a session stop procedure based on the result of determination on whether or not UE 50 needs reception.

### 2. The Second Embodiment

Next, the second embodiment will be described.

Hereinbelow, the best mode for carrying out the present invention will be described with reference to the drawings.

[2.1 System Configuration]

FIG. 15 is a diagram for illustrating the scheme of a mobile communication system 2 in a case to which the present invention is applied. Mobile communication system 2 is comprised of a BM-SC (Broadcast Multicast Service Center) 2010 as a broadcast-multicast service center, a core network 6 including an MBMS GW (MBMS Gateway) 2020 as a gateway device and an MME (Mobility Management Entity) 2030 as a service control device, an eNB 2040 as a base station device and a UE 2050 as a mobile station device.

Connected to core network 6 is eNB 2040, to which UE 2050 is connectable. Specifically, MBMS GW 2020 is connected to the downstream side of BM-SC 2010. MME 2030 and eNB 2040 are connected to the downstream side of MBMS GW 2020. Further, eNB 2040 is connected to the downstream side of MME 2030.

MBMS GW 2020 and MME 2030, as well as MME 2030 and eNB 2040, are connected to each other to transmit and receive control information. Further, MBMS GW 2020 and eNB 2040 are connected to each other to transmit and receive broadcast data. Moreover, UE 2050 is connected to the downstream side of eNB 2040.

Here, in FIG. 15 of the present embodiment, for description convenience, only one device is shown for each component device though multiple devices are connected. For example, mobile communication system 2 includes one or multiple MBMS GWs, which each have one or multiple MMES 2030 and eNBs connected on the downstream side thereof. Further, one or multiple UEs can be connected to the eNB.

[2.2 Device Configuration]

Next, the functional configuration of each device will be described using drawings.

[2.2.1 BM-SC]

The functional configuration of BM-SC 2010 will be described with reference to FIG. 16. BM-SC 2010 includes a controller 2100 to which a transceiver 2110 and a storage 2120 are connected.

Transceiver 2110 is an interface unit connected to a network, and is connected to, for example MBMS GW 2020 via the network.

Storage 2120 is a functional unit in which various programs, and various data, necessary for BM-SC 2010 to operate are stored. Storage 2120 may include a semiconductor memory, HDD (Hard Disk Drive) and the like. In the present embodiment, an MBMS service DB 2122 and an MBMS bearer context 2124 are stored therein.

MBMS service DB 2122 is a DB for storing a service identifier of distributed data for each MBMS bearer service in order to manage distributable MBMS bearer services. FIG. 17 shows one example of a data configuration of MBMS service DB 2122.

Here, various kinds of identifiers may be used as the service identifier. For example, used are:

(1) TMGI (Temporary Mobile Group Identity) that identifies an MBMS bearer context,
(2) other identifiers (e.g., an identifier is assigned by an operator implementing a service operation by using BM-SC 2010), and the like. The present embodiment will be described on the assumption that (1) TMGI is used.

Specifically used is TMGI that identifies an MBMS bearer context created for each service when broadcast data is distributed by an MBMS bearer service. Though TMGI is temporarily assigned subscriber ID information that is used in conventional mobile phone services, in MBMS bearer service this is used as the information for identifying the MBMS bearer service.

MBMS bearer context 2124 is management information, created for each MBMS bearer service and relating to the MBMS bearer which is established to deliver broadcast data. FIG. 18 shows one example of a data configuration of MBMS bearer context 2124.

Specifically, the MBMS bearer context includes an MBMS bearer service identifier such as TMGI etc. (e.g., “TGMI1”), the identifier of a session to be established for distribution (e.g., “session ID”), the mode for discriminating either multicast mode or broadcast mode (e.g., “broadcast mode”), status information for managing the state of the MBMS bearer, being either active or suspended (e.g., “active”), a distribution node to which data is delivered (e.g., “MBMS GW 2020”), and a UE counter (e.g., “N”).

Herein, as the distribution node, information for identifying the distribution node is stored. For example an IP address (the IP address of MBMS GW 2020 in the case of FIG. 18) is stored. Multiple distribution nodes can also be stored.

The UE counter shows the number of terminals that distribute broadcast data of the MBMS bearer service. This is based on the number counted by the counting function of the base station device, or the number of terminals through which users are actually receiving content, or the like.

Further, BM-SC 2010 stores a different UE counter for each MBMS GW so as to be able to count the numbers of UEs when information on multiple MBMS GWs as distribution nodes is stored in MBMS bearer context 2124. Accordingly, BM-SC 2010 can store the number of terminals that are using the broadcast data delivered to MBMS GW 2020.

[2.2.2. MBMS GW]

Next, the functional configuration of MBMS GW 2020 will be described with reference to FIG. 19. MBMS GW 2020 includes a controller 2200 to which a transceiver 2210 and a storage 2220 are connected.

Transceiver 2210 is an interface unit connected to a network, and is connected to, for example BM-SC 2010, MME 2030 and eNB 2040 via the network.

Storage 2220 is a functional unit in which various programs, and various data, necessary for MBMS GW 2020 to operate are stored. Storage 2220 may include a semiconductor memory, HDD (Hard Disk Drive) and the like. In the present embodiment, an MBMS bearer context 2222 and an upstream control node DB 2224 are stored therein.

MBMS bearer context 2222 is management information, created for each MBMS bearer service and necessary for delivering broadcast data. FIG. 20 shows one example of a data configuration of MBMS bearer context 2222.

Specifically, the MBMS bearer context includes an MBMS bearer service identifier such as TMGI etc. (e.g., “TGMI 1”), the identifier of a session to be established for distribution (e.g., “session ID”), an IP multicast address for performing IP multicast communication (e.g., “IP multicast address 1”), the mode for discriminating either multicast mode or broadcast mode (e.g., “broadcast”), status information for managing the state of the MBMS bearer, being either active or suspended (e.g., “active”), an MBMS control device (e.g., “MME 2030”) for transmitting and receiving control information, a distribution node to which data is delivered (e.g., “eNB 2040”), and a UE counter (e.g., “N”).

The MBMS control device stores information for identifying a management device for transmitting and receiving control information: for example, an IP address (the IP address of MME 2030 in the case of FIG. 20) is stored.

As the distribution node, information for identifying the distribution node is stored. For example an IP address (the IP address of eNB 2040 in the case of FIG. 20) is stored. Multiple distribution nodes may also be stored.

The IP multicast address is stored for each MBMS bearer service for which an MBMS bearer context is created.

The UE counter shows the number of terminals that receive broadcast data of the MBMS bearer service. This is based on the number counted by the counting function of the base station device, or the number of terminals through which users are actually receiving content, or the like.

Further, MBMS GW 2020 stores a different UE counter for each eNB so as to be able to count the numbers of UEs when information on multiple eNBs as distribution nodes is stored in MBMS bearer context 2222. Accordingly, MBMS GW 2020 can store the number of terminals that are using the broadcast data delivered to eNB 2040.

Upstream control node DB 2224 is a DB for storing information for identifying the upstream broadcast data node delivering device. FIG. 21 shows one example of a configuration of upstream control node DB 2224. In the present embodiment, the IP address of BM-SC 2010 is stored. Herein, upstream control node DB 2224 may store one broadcast data node delivering device (BM-SC 2010) as shown in FIG. 21, or multiple BM-SCs corresponding to different MBMD services, each creating an MBMS bearer context that can be distinguished by TMGI or the like.

[2.2.3 MME]

Subsequently, the functional configuration of MME 2030 will be described with reference to FIG. 22. MME 2030 includes a controller 2300 to which a transceiver 2310 and a storage 2320 are connected.

Transceiver 2310 is an interface unit connected to a network, and is connected to, for example MBMS GW 2020 and eNB 2040 via the network.

Storage 2320 is a functional unit in which various programs, and various data, necessary for MME 2030 to operate are stored. Storage 2320 may include a semiconductor memory, HDD (Hard Disk Drive) and the like. In the present embodiment, an MBMS bearer context 2322 is stored therein.

MBMS bearer context 2322 is management information, created for each MBMS bearer service and necessary for delivering broadcast data. FIG. 23 shows one example of a data configuration of MBMS bearer context 2322.

Specifically, the MBMS bearer context includes an MBMS bearer service identifier such as TMGI etc. (e.g., “TGMI1”), the identifier of a session to be established for delivery (e.g., “session ID”), an IP multicast address for performing IP multicast communication (e.g., “IP multicast address 1”), the mode for discriminating either multicast mode or broadcast mode (e.g., “broadcast”), status information for managing the state of the MBMS bearer, being either active or suspended (e.g., “active”), a superior distribution node to be the distribution node in the higher rank of eNB 2040 (e.g., “MBMS GW 2020”), a distribution node to which data is delivered from MME 2030 (e.g., “eNB 2040”), and a UE counter (e.g., “N”).

Herein, as the distribution node and superior distribution node, information for identifying each node is stored. For example, IP addresses (the IP addresses of eNB 2040 and MBMS GW 2020 in the case of FIG. 23) are stored. Multiple distribution nodes may also be stored.

The IP multicast address is stored for each MBMS bearer service for which an MBMS bearer context is created.

The UE counter shows the number of terminals that receive distributed data of the broadcast service. This is based on the number counted by the counting function of the base station device, or the number of terminals through which users are actually receiving content, or the like.

Further, MME 2030 stores a different UE counter for each eNB so as to be able to count the numbers of UEs when information on multiple eNBs as the distribution node is stored in MBMS bearer context 2322. Accordingly, MME 2030 can store the number of terminals that are using the broadcast data MBMS GW 2020 delivers to eNB 2040.

[2.2.4 eNB]

Subsequently, the functional configuration of eNB 2040 will be described with reference to FIG. 24. In eNB 2040, a transceiver 2410 and a storage 2420 are connected to a controller 2400.

Transceiver 2410 is an interface unit connected to a network, and is connected to, for example MBMS GW 2020 and MME 2030 via the network, and can be connected to UE 2050.

Storage 2420 is a functional unit in which various programs, and various data, necessary for eNB 2040 to operate are stored. Storage 2420 may include a semiconductor memory, HDD (Hard Disk Drive) and the like. In the present embodiment, an MBMS bearer context 2422 and a radio frame information 2424 are stored therein.

MBMS bearer context 2422 is management information, created for each MBMS bearer service and necessary for delivering broadcast data. FIG. 25 shows one example of a data configuration of MBMS bearer context 2422.

Specifically, the MBMS bearer context includes an MBMS bearer service identifier such as TMGI etc. (e.g., “TGMI1”), the identifier of a session to be established for delivery (e.g., “session ID”), an IP multicast address for performing IP multicast communication (e.g., “IP multicast address 1”), the mode for discriminating either multicast mode or broadcast mode (e.g., “broadcast”), status information for managing the state of the MBMS bearer, being either active or suspended (e.g., “active”), a superior distribution node to be the distribution node in the higher rank (e.g., “MBMS GW 2020”), an MBMS control device (e.g., “MME 2030”) for transmitting and receiving control information, and a UE counter (e.g., “N”).

Herein, the MBMS control device stores information for identifying a management device for transmitting and receiving control information: for example, an IP address (the IP address of MME 2030 in the case of FIG. 25) is stored.

Herein, as the superior distribution node, information for identifying the node is stored. For example, an IP address (the IP address of MBMS GW 2020 in the case of FIG. 25) is stored.

The UE counter shows the number of terminals that receive distributed data of the broadcast service, and is based on the number counted by the counting function of the base station device. Specifically, this is the number of terminals through which users are actually receiving content, or the like.

As radio frame information 2424, information on the radio frame which is used by eNB 2040 to perform transmission to UE 2050 in the radio section is stored for each MBMS bearer service. FIG. 26 shows an example of a data configuration of radio frame information 2424.

Specifically, for each identifier for identifying an MBMS bearer service (for each TMGI, for example), mode information representing either multicast mode or unicast mode (e.g., “frame mode”) is stored. Further, in the case of unicast mode, ID information such as the IMSI (International Mobile Subscriber Identity) of the target UE 2050 of frame delivery is stored. Here, a plurality of target UEs (ID information) of frame delivery may be stored.

[2.3 Procedural Processing]

Next, the procedural processing of mobile communication system 2 in the present embodiment will be described using drawings.

[2.3.1 Service Announcement Procedure]

To begin with, BM-SC 2010 performs a service announcement procedure to UE 2050, as shown in FIG. 27. BM-SC 2010 notifies UE 2050 of distributable services (S2100). From this notice, UE 2050 detects the broadcast services.

BM-SC 2010 notifies the possibility of distribution of services managed by MBMS service DB 122 to UE 2050 by giving notice of service identifiers. Further, information for explaining the services, such as program titles, content titles, start times of distribution, etc. may be additionally notified.

Here, various kinds of identifiers may be used as the service identifier. For example,

### (1) TMGI,

(2) other identifiers (e.g., other identifiers that are designated the operator and can be used to discriminate MBMS bearer services), and the like can be used. The present embodiment will be described on the assumption that (1) TMGI is used.

Specifically, a flow identifier is stored in MBMS bearer context 2124 so that the flow identifier corresponding to the TMGI can be used.

Various specific methods can be considered to give notice. For example, SMS (Short Message Service) or the like may be used to give notice to distributable UEs 2050 that are registered in advance or to unspecified large number of UEs 2050, or information may be put up on a bulletin board on the web so that UE 2050 can access the web server to get the information.

[2.3.2 Session Start Procedure]

A session start procedure to be executed next will be described with reference to FIG. 27. The session start procedure sets up an MBMS bearer and establishes a communication path.

BM-SC 2010 selects a service and transmits a session start request to MBMS GW 2020 (S2300). In this step, a TMGI for designating a service and a session identifier for identifying the session are created, and these are included in the session start request to be transmitted. Thus, a session start procedure starts.

Further, the BM-SC creates MBMS bearer context 2124, entering the TMGI and the session identifier into the MBMB bearer context 2124 and setting the status information to be “active”.

As the distribution node, information on MBMS GW 2020 is stored. A plurality of MBMS GWs can be registered as the distribution node.

The recipient node (MBMS GW) to be registered may be entered in advance by the operator, or a list of distribution nodes (MBMS GWs 2020 etc.) for every MBMS service area has been registered, so that the identifier of the MBMS service area is included in the session start request to be transmitted. Then, a corresponding MBMS GW can be selected and registered based on the transmitted MBMS service area identifier.

Further, the timing at which BM-SC 2010 starts the session start procedure may be triggered at the moment the aforementioned service announcement procedure is completed, or the session start procedure may be started even before its completion, at an any timing in accordance with the operator's policy or the like.

The session start request is transmitted to all the MBMS GWs 2020 registered as the distribution node in MBMS bearer context 2124.

Subsequently, MBMS GW 2020 receives the session start request and transmits a session start response to BM-SC 2010 to reply (S2302). Further, the MBMS GW creates MBMS bearer context 2222, entering the TMGI and the session identifier in the context and setting the status information to be “active”.

As the MBMS control device, information on MME 2030 is stored. MME 2030, the MBMS control device to be registered may be entered in advance by the operator, or BM-SC 2010 may transmit the information on the previously registered MBMS control by operator's setting together with the session start request, so that the MBMS GW can register the information. In this case, MBMS GW 2020 does not need to hold information on MME 2030 in advance.

As the distribution node, information on eNB 2040 is stored. A plurality of eNBs 2040 can be registered as the distribution node.

Here, eNB 2040, the distribution node to be registered may be entered in advance by the operator, or a list of distribution nodes (eNBs 2040, etc.) for every MBMS service area has been registered so that a corresponding eNB 2040 can be selected based on the MBMS service area identifier included in the session start request transmitted from BM-SC 2010. In this case, MBMS GW 2020 does not need to hold information on the list of eNBs 2040 in advance.

The procedure described heretofore establishes an MBMS bearer as the delivery path that assures communication quality for broadcast data delivery between BM-SC 2010 and MBMS GW 2020.

Further, in order to enable the transmission by the MBMS bearer to achieve IP multicast communication, an IP multicast address is assigned to the service and registered in MBMS bearer context 2222.

MBMS GW 2020 transmits a session start request to MME 2030 that is registered as the distribution node in MBMS bearer context 2222 (S2304). In order to designate a service, the session start request includes the TMGI, session identifier and IP multicast address.

MME 2030 receives the session start request and transmits a session start response to MBMS GW 2020 to reply (S2310). The MME may transmit the session start response after sending a session start request to eNB 2040 (S2306) and receiving its response (S2308) as described below.

Further, the MEE creates MBMS bearer context 2322, entering the TMGI, the session identifier and the IP multicast address in the context and setting the status information to be “active”.

As the distribution node, information on eNB 2040 is stored. A plurality of eNBs can be registered as the distribution node.

Herein, eNB 2040, the distribution node to be registered may be entered in advance by the operator, or a list of distribution nodes (eNBs 2040 etc.) for every MBMS service area has been registered so that a corresponding eNB can be selected based on the MBMS service area identifier included in the session start request transmitted from MBMS GW 2020.

Further, information on MBMS GW 2020, the superior distribution node to which the request was sent is registered (the IP address in the present embodiment).

MME 2030 transmits a session start request to eNB 2040 that is registered as the distribution node in MBMS bearer context 2322 (S2306). The session start request includes the TMGI, session identifier and IP multicast address.

The session start request is also transmitted to all the eNBs registered as the distribution node in MBMS bearer context 2322.

The eNB 2040 receives the session start request and transmits a session start response to MME 2030 to reply (S2308). Further, the eNB creates MBMS bearer context 2422, entering the TMGI, the session identifier and the IP multicast address in the context and setting the status information to be “active”.

The eNB registers information on MME 2030 to be the MBMS control device to which the request was sent. Further, information on MBMS GW 2020 to be the superior distribution node is registered. MBMS GW 2020 may be selected from those that have been registered in advance by operator's setting or the like, or MME 2030 may transmit a session start request including MBMS GW 2020 so that the eNB registers it.

The procedure described heretofore establishes an MBMS bearer as the delivery path that assures communication quality for broadcast data delivery between MBMS GW 2020 and eNB 2040.

At this point, eNB 2040 performs an IP multicast joining process (S2314). The eNB 2040, referring to MBMS bearer context 2422, makes a join request using the IP multicast address corresponding to the service. Specifically, in the case of IPv4 communication, the NB sends an IGMP Membership Report message. In the case of IPv6, the NB sends an MLD Membership Report.

As a result, IP multicast packets are delivered through the MBMS bearer established between BM-SC 2010, MBMS GW 2020 and eNB 2040. Broadcast data is transmitted from BM-SC 2010 to eNB 2040 by IP multicast.

Further, eNB 2040 performs an assignment process of radio resources for transmission to the UE (S2310) and registers the information for delivery into radio frame information 2424. Specifically, mode information on which mode, multicast mode or unicast mode is used as the radio frame is registered for every service identifier. As the service identifier, TMGI can be used.

In a case of transmission in multicast mode, the frame does not need to retain UE information because it is transmitted to unspecified large number of UEs. On the other hand, in the case of transmission in unicast mode, it is necessary to transmit radio frames to individual UEs. Therefore, in this case, IMSI is registered as UE information and registered as UE information at the initial connection of UE 2050 to eNB 2040 in the service announce procedure. As a result of the service announcement procedure and session start procedure described heretofore, a communication path is established between UE 2050 and BM-SC 2010 so that data transmitted from the BM-SC can be delivered to eNB 2040.

Herein, though in the above example the service announcement procedure is performed first, then the session start procedure is performed, these procedures may be done in the reverse order.

At last, eNB 2040 sends an MBMS start notice to UE 2050 (S2316). The start notice to be sent should include the service identifier for identifying the service. Hereby, UE 2050 starts reception of broadcast data.

Herein, various kinds of identifiers may be used as the service identifier. For example,

(1) the TMGI registered in MBMS bearer context 2422,
(2) the session ID registered in MBMS bearer context 2422,
(3) other identifiers (e.g., an identifier that permits eNB 2040 and UE 2050 to identify an MBMS bearer service) and the like can be used. In this embodiment, description will be made on the assumption that (1) TMGI is used.

Instead of eNB 2040 notifying MBMS start, BM-SC 2010 may notify the service identifier to UE 2050 by the service announcement procedure or the like. The method of notification can be given selectively in accordance with the operator's policy.

Though the above example was described referring to the process when MBMS GW 2020 receives a session start request, the same procedure as that of the MBMS GW 2020 is carried out when another MBMS GW receives a session start request from BM-SC 2010.

Similarly, though the example as to the eNB was described referring to a process when eNB 2040 receives a session start request, the same procedure as that of eNB 2040 is carried out when another eNB receives a session start request from MME 2030.

Similarly, though the example as to the UE was described referring to the process when UE 2050 receives a session start request, the same procedure as that of UE 2050 is carried out when another UE receives a session start request from the eNB.

Hereby, the broadcast data distributed by BM-SC 2010 is delivered to the UE via multiple entities, MBMS GW and eNB in a top-down manner.

[2.3.3 Distribution Stop Procedure]

Next, a session stop procedure will be described with reference to FIG. 28. Though description will be made on an example in which the session stop procedure starts based on the result of the counting procedure at eNB 2040, the procedure can be started by eNB 2040, by any other start trigger than this.

To begin with, the counting procedure to be the trigger of a session stop procedure will be described. This procedure is proceeded between eNB 2040 and UE 2050. The eNB 2040 transmits to UE 2050 being connected, a message with service identifiers to confirm whether a service is being received.

Herein, eNB 2040 sends the message for confirming whether a service is received or not, to the UEs 2050 registered in radio frame information 2424, but may transmit to all the UEs 2050 being connected.

Herein, various kinds of identifiers may be used as the service identifier. For example,

(1) the TMGI registered in MBMS bearer context 2422,
(2) the session ID registered in MBMS bearer context 2422,
(3) other identifiers (e.g., an identifier that permits eNB 2040 and UE 2050 to identify an MBMS bearer service) and the like can be used. In this embodiment, description will be made on the assumption that (1) TMGI is used.

As receiving the message, UE 2050 makes a reply including a service identifier, to eNB 2040. As the service identifier, the TMGI included in received message can be used.

Even if UE 2050 has received an MBMS bearer service start notice and is ready for reception of broadcast data, the UE does not need to send a reply when reception is not necessary, for example, in a case where the application for receiving content is turned off and in other cases.

Herein, various kinds of identifiers may be used as the service identifier. For example,

(1) the TMGI registered in MBMS bearer context 2422,
(2) the session ID registered in MBMS bearer context 2422,
(3) other identifiers (e.g., an identifier that permits eNB 2040 and UE 2050 to identify an MBMS bearer service) and the like can be used. In this embodiment, description will be made on the assumption that (1) TMGI is used.

Hereby, eNB 2040 can acquire the number of UEs 2050 that actually need to receive broadcast data. The obtained number of UEs 2050 is registered in the UE counter of MBMS bearer context 2422.

The eNB 2040 may transmit the message for confirmation without including service identifiers. In this case, if UE 2050 needs to receive a service, the UE makes a reply including its service identifier. UE 2050 can select a service by registering service identifiers acquired from the service announcement procedure.

The eNB 2040 having received the response identifies the MBMS bearer context from the service identifier and registers the number of UEs 2050 that made a reply, into the UE counter. Thus, the counting procedure (S2400) is completed.

The eNB 2040 performs a counting process to confirm whether the UE counter of MBMS bearer context 2422 is zero (S2402). When the UE counter is zero, the NB determines to temporarily suspend the session. Accordingly, when detecting no UE 2050 receiving for each service, the NB temporarily suspends the session of the service.

The eNB 2040 transmits a session stop request including the TMGI registered in MBMS bearer context 2422, the service identifier, the flow identifier and information on eNB 2040, to MME 2030 (S2404). The MME to which the request is transmitted is solved based on information on the MBMS control device (MME 2030) in MBMS bearer context 2422. Further, the status information in MBMS bearer context 2422 is set to be “standby”.

Herein, when the UE counter is zero, the eNB stops distribution and reception of the broadcast data corresponding to the service (S2408).

Here, to stop reception, an IP multicast separation request may be transmitted (S2408). Specifically, in the case of IPv4 communication, an IGMP Membership Report message is sent. In the case of IPv6, an MLD Membership Report is sent. Hereby, distribution and reception of IP multicast packets are stopped. Stoppage of distribution and reception of IP multicast packets stops distribution and reception of broadcast data.

MME 2030 receives the session stop request and sends a session stop response to eNB 2040 (S2406). Further, MME 2030 transmits a session stop request including the TMGI registered in MBMS bearer context 2422, the service identifier and information on eNB 2040, to MBMS GW 2020 (S2410). As to the recipient MBMS GW, the request is transmitted to address of the MBMS GW registered in MBMS bearer context 2422.

Further, MME 2030 sets the UE counter associated with eNB 2040 to zero. Also, the MME deletes the entry of eNB 2040 from the distribution node in the MBMS bearer context or checks the entry with a mark indicating “suspended”.

Herein, when MME 2030 is not distributing the broadcast data to other eNBs, the status information in MBMS bearer context 2322 is set to be “standby”. Whether or not there is any distribution of broadcast data to other eNBs can be determined from the fact that there is no eNB entry in the distribution node of MBMS bearer context 2322 or from the fact that all the eNBs are checked with a mark indicating “suspended”.

MBMS GW 2020 receives the session stop request and sends a session stop response to MME 2030 (S2412).

Further, MBMS GW 2020 sets the UE counter associated with eNB 2040 to zero, and stops distribution and reception of the broadcast data of the corresponding service for eNB 2040 (S2420).

Here, to stop reception, an IP multicast separation request may be transmitted. Specifically, in the case of IPv4 communication, an IGMP Membership Report message is sent. In the case of IPv6, an MLD Membership Report is sent. Hereby, distribution and reception of IP multicast packets are stopped. Stoppage of distribution and reception of IP multicast packets stops distribution and reception of broadcast data.

Also, the entry of eNB 2040 is deleted from the distribution node of MBMS bearer context 2222 or is checked with a mark indicating “suspended”.

Herein, when MBMS GW 2020 is not distributing the broadcast data to other eNBs, the MBMS GW transmits a session stop request to BM-SC 2010 (S2416). Whether or not there is any distribution of broadcast data to other eNBs can be determined from the fact that there is no eNB entry in the distribution node of MBMS bearer context 2222 or from the fact that all the eNBs are checked with a mark indicating “suspended”. The session stop request is included with the TMGI registered in MBMS bearer context 2222, the session identifier and information on MBMS GW 2020, and transmitted.

Further, MBMS GW 2020 releases the resources for the MBMS bearer between eNB 2040 and itself. In other words, MBMS GW 2020 releases the resources of the MBMS bearer when delivery of broadcast data to eNB 2040 is stopped. In this case, the status information in MBMS bearer context 2222 is registered to be “standby”.

When other multiple eNBs 2040 have been registered in the distribution node of MBMS bearer context 2222 and distribution of broadcast data is in progress, the MBMS GW ends the session stop procedure without transmitting a session stop request to BM-SC 2010.

BM-SC 2010 receives the session stop request and sends a session stop response to MBMS GW 2020 (S2418).

Further, BM-SC 2010 releases the resources for the MBMS bearer between MBMS GW 2020 and itself. In other words, BM-SC 2010 releases the resources of the MBMS bearer when there is no broadcast data to be transmitted to MBMS GW 2020.

The BM-SC stops delivery of the broadcast data of the corresponding service to MBMS GW 2020 (S2422).

The BM-SC 2010 sets the UE counter associated with MBMS GW 2020 to zero, and deletes the entry of MBMS GW 2020 from the distribution node or checks the MBMS GW with a mark indicating “suspended”.

Further, when the entry of all the MBMS GWs 2020 is deleted or checked with a mark indicating “suspended”, the status information in MBMS bearer context 2124 is set to be “standby”.

Thus, the above procedure enables eNB 2040 to initiatively stop the session temporarily. Based on the counting procedure, the session stop procedure by eNB 2040 makes it possible to detect that delivery of the broadcast service for each MBMS bearer that can be identified by TMGI etc., is unnecessary. Further, it is also possible to start when detecting no one receiving content as in a case where no one is watching or listening content because of the application etc., being off. Then, this detection can be used to trigger a session stop procedure.

Alternatively, the session stop procedure may be practiced only for broadcast services. The conventional MBMS bearer services include services in multicast mode and services in broadcast mode. The broadcast mode service is a service that does not control subscriber information of UE 2050 and does not need authorization for reception as described heretofore. In contrast, the multicast mode service is a service that requires an authorization procedure for each service in response to a join request of UE 2050 to start distribution.

Accordingly, the delivery in multicast mode is a delivery to a particular UE, hence it should be presumed that there is a case in which temporal release of the MBMS bearer of a service and failure to recover resources at the restart of the service is not allowed. To deal with this, it is necessary to provide a method of temporarily suspending a service for broadcast mode only.

As a specific method of permitting the session stop procedure for broadcast services only, in the session start procedure described in FIG. 27, when BM-SC 2010 creates a TMGI upon creation of the MBMS bearer context and notifies the TMGI to MBMS GW 2020, MME 2030 and eNB 2040, the mode is notified at the same time. To control which mode, multicast mode or broadcast mode, should be notified, each service may be associated with a mode in advance and managed in MBMS service DB 2122, or may be managed based on the presence or absence of the authorization step in the service activation procedure defined in the process of communication establishment in the multicast mode.

In this way, every device can know that the service to be registered is of broadcast mode and hold it in respective MBMS bearer contexts. Specifically, BM-SC 2010 registers “broadcast” as the mode of MBMS bearer context 2124, MBMS GW 2020 registers “broadcast” as the mode of MBMS bearer context 2222, MME 2030 registers “broadcast” as the mode of MBMS bearer context 2322, and eNB 2040 registers “broadcast” as the mode of MBMS bearer context 2422.

Hereby, to determine stoppage of a session, each device can stop the session by referring to the MBMS bearer context when the service is in broadcast mode. Specifically, when transmitting a broadcast session stop request (S2404), eNB 2040 performs transmission of a stop request, release of the MBMS bearer and stoppage of distribution and reception of broadcast data when “broadcast” is registered as the mode in MBMS bearer context 2422 (S2408). MME 2030, when transmitting a broadcast session stop request (S2410), performs transmission of a stop request, release of the MBMS bearer and stoppage of distribution and reception of broadcast data when “broadcast” is registered as the mode in MBMS bearer context 2322 (S2414).

MBMS GW 2020, when transmitting a broadcast session stop request (S2416), performs transmission of a stop request, release of the MBMS bearer and stoppage of distribution and reception of broadcast data when “broadcast” is registered as the mode in MBMS bearer context 2222 (S2420). BM-SC 2010, when receiving a multicast session stop request (S2416), performs release of the MBMS bearer and stoppage of broadcast data distribution when “broadcast” is registered as the mode in MBMS bearer context 2124 (S2422).

Conventionally, only the sender of content data, i.e., BM-SC 2010 can initiatively perform a temporary suspension of the session by detecting that there is no data to be transmitted, such as a case that there is no data to be transmitted in a certain period of time depending on the status of delivery data in BM-SC 2010. Therefore, it has been impossible for eNB 2040 to stop the session even if eNB 2040 can check whether UE 2050 needs reception or not and can detect that data distribution is unnecessary. The procedure of the present embodiment makes it possible for eNB 2040 to initiatively perform a session stop procedure based on the result of determination on whether or not UE 2050 needs reception.

### 3. Variational Examples

As the embodiments of this invention have been described in detail with reference to the drawings, the specific configuration should not be limited to the embodiments. Designs and others that do not depart from the gist of this invention should also be included in the scope of claims.

The program to be operated in each device of each embodiment is a program (program that makes a computer function) for controlling the CPU or the like so as to realize the functions of the above embodiments. The data to be handed in these devices is temporarily stored in a temporary memory (e.g., RAM) at the time of processing, then is stored into a storage such as ROM, HDD or the like and is read out, modified and written in by the CPU, as necessary.

Herein, the recording medium for storing the program may be any of semiconductor mediums (e.g., ROM, non-volatile memory card, etc.), optical recording mediums/magneto optical mediums (e.g., DVD (Digital Versatile Disc), MO (Magneto Optical Disc), MD (Mini Disc), CD (Compact Disc), BD and the like), magnetic recording mediums (e.g., magnetic tape, flexible disc, etc.), and the like. Further, the functions of the above-described embodiments are not only realized by executing the loaded program, but the functions of the present invention may also be realized in accordance with the instructions of the program being executed in cooperation with an operating system, another application program or the like.

To put the product on the market, the program may be stored on a removable storing medium, or may be transferred to a server computer connected to a network such as the Internet or the like. In this case, the storage device of the server computer is also included in the present invention.

Further, the whole or part of each device in the above-described embodiments may also be typically realized by an LSI as an integrated circuit. Each functional block of each device may be given individually in the form of a chip, or the whole or part may be integrated into a chip. The method of circuit integration may be realized in the form of a dedicated circuit or general purpose processing unit, not limited to LSI. It goes without saying that if a technology of circuit integration replacing LSI technologies appears with the progress of semiconductor technologies, the integrated circuit based on that technology can also be used.

### DESCRIPTION OF REFERENCE NUMERALS

10 BM-SC
   100 controller
   110 transceiver
   120 storage
      122 MBMS service DB
      124 MBMS bearer context
20 GGSN
   200 controller
   210 transceiver
   220 storage
      222 MBMS bearer context
      224 upstream control node DB
30 SGSN
   300 controller
   310 transceiver
   320 storage
      322 MBMS bearer context
40 NB
   400 controller
   410 transceiver
   420 storage
      422 MBMS bearer context
      424 radio frame information
50 UE
2010 BM-SC
   2100 controller
   2110 transceiver
   2120 storage
      2122 MBMS service DB
      2124 MBMS bearer context
2020 MBMS GW
   2200 controller
   2210 transceiver
   2220 storage
      2222 MBMS bearer context
      2224 upstream control node DB
2030 MME
   2300 controller
   2310 transceiver
   2320 storage
      2322 MBMS bearer context
2040 eNB
   2400 controller
   2410 transceiver
   2420 storage
      2422 MBMS bearer context
      2424 radio frame information
2050 UE

1-22. (canceled)

23. A base station device connected to a mobile communication system that performs distribution of broadcast data by an MBMS bearer service, from a BM-SC (Broadcast Multicast Service Center) to a mobile station device that is connected to a base station device, via a GGSN (Gateway GPRS Support Node) and an SGSN (Service GPRS Support Node) for which an MBMS (Multimedia Broadcast/Multicast Service) bearer has been established, wherein,
in the MBMS bearer service, information on the MBMS bearer established by assigning MBMS bearer resources is included in an MBMS bearer context, and
the base station device transmits a session stop request associated with the MBMS bearer context to the SGSN when stopping the distribution of broadcast data associated with the MBMS bearer context, and stops distribution of broadcast data to thereby release the MBMS bearer resources between the base station device and the SGSN.

24. A base station device connected to a mobile communication system that performs distribution of broadcast data by an MBMS bearer service, from a BM-SC (Broadcast Multicast Service Center) to a mobile station device that is connected to a base station device, via an MBMS GW (MBMS Gateway) and an MME (Mobility Management Entity) for which an MBMS (Multimedia Broadcast/Multicast Service) bearer has been established, wherein,
the MBMS bearer context further includes a service identifier for identifying an MBMS bearer service, and
the base station device transmits a session stop request associated with the MBMS bearer context to the MME when stopping the distribution of broadcast data associated with the MBMS bearer context, and stops distribution of broadcast data to thereby release the MBMS bearer resources between the base station device and the MME.

25. An MBMS GW connected to a mobile communication system that performs distribution of broadcast data by an MBMS bearer service, from a BM-SC (Broadcast Multicast Service Center) to a mobile station device that is connected to a base station device, via an MBMS GW (MBMS Gateway) and an MME (Mobility Management Entity) for which an MBMS (Multimedia Broadcast/Multicast Service) bearer has been established, wherein,
the MBMS bearer context further includes a service identifier for identifying an MBMS bearer service,
the base station device transmits a session stop request associated with the MBMS bearer context to the MME when stopping the distribution of broadcast data associated with the MBMS bearer context,
the MME transmits a session stop request associated with the MBMS bearer context to the MBMS GW when stopping the distribution of broadcast data associated with the MBMS bearer context, in accordance with the session stop request transmitted from the base station device, and
the MBMS GW transmits a session stop request associated with the MBMS bearer context to the BM-SC when there is no mobile station device that is being connected via the MBMS GW and receiving distribution of broadcast data, in accordance with the session stop request transmitted from the MME, and stops distribution of broadcast data to thereby release the MBMS bearer resources between the MBMS GW and the BM-SC.
